(19) United States
(12) Patent Application Publication
(10) Pub. No.: US 2004/0090970 A1
(43) Pub. Date: May 13, 2004

(54) Distribution of data flows to local loop subscribers by an access multiplexer

(76) Inventors: Cheryl A. Sanchez, Wesford, MA (US); Franklin B. Herman, Sutton, MA (US); Lisa Yago Garvin, Petaluma, CA (US); Ravi Medikonda, San Ramon, CA (US)

Correspondence Address: SILICON VALLEY PATENT GROUP LLP, 2350 MISSION COLLEGE BOULEVARD, SUITE 360, SANTA CLARA, CA, 95054, US

(21) Appl. No.: 10/292,387

(22) Filed: Nov. 11, 2002

(51) Int. Cl. H04L 12/28; H04L 12/56; H04N 7/16; H04N 7/173

(52) U.S. Cl. 370/397; 725/118; 725/148; 370/409; 370/395.1

(57) ABSTRACT

An apparatus that supports a communication link (such as DSL) in the local loop has hardware to distribute a copy of one or more data flows to any of a number of devices (e.g. “set-top boxes”) that are each connected to the apparatus by the link. In some embodiments, the apparatus receives only one copy of a number of video feeds for distribution from a video head end that is coupled thereto e.g. via an ATM network. In such embodiments, the apparatus selectively transfers a copy of one of the video feeds being received, to each set-top box. Distribution of data flows in the apparatus can be implemented by a point to multipoint virtual circuit, although a change in a video feed being supplied to a subscriber requires tearing down the subscriber's old virtual circuit leaf and setting up a new virtual circuit leaf to the subscriber. The time delay and overhead associated with such virtual circuit changes are eliminated in certain embodiments by changing only an internal mapping. Specifically an association between a subscriber's virtual circuit and a first virtual circuit carrying the currently-supplied video feed is erased, and a new association is formed between the subscriber's virtual circuit and a second virtual circuit that is carrying the video feed to be supplied. During such a change, the subscriber's virtual circuit is kept intact (and in addition, the first and second virtual circuits are kept intact as well), because a simple change in VC-VC associations implements channel change.

### BACKGROUND

A subscriber can receive broadband services over an existing telephone line by use of a Digital Subscriber Line (DSL) modem. Such modems are typically connected to a Remote Terminal (RT) that contains a DSL Access Multiplexer (DSLAM), or alternatively the modems may be connected directly to a DSLAM in a central office (CO), depending on the distance between the subscriber and the CO. An RT is normally connected to the CO by one or more high speed trunks (e.g. DS-3 or OC-3). Such an access network can be used by a local exchange carrier (LEC) to distribute video to subscribers, in order to compete with cable operators. The specific manner in which an access network is to be used to distribute video has been the subject of a number of studies in the prior art, examples of which are briefly discussed below and in greater detail in each of the respective references.

WO 02/43301 A2 filed by Starguide Digital Networks Inc and published on May 30, 2002 describes a device (called “IP ATM Multicaster” and abbreviated “IAM”) that converts multicast signals in conformance with the Internet Protocol (IP) into the asynchronous transfer mode “ATM” protocol, and replicates the converted IP multicast packets in response to join requests in conformance with Internet Group Management Protocol (IGMP) that are received from one or more prospective multicast content recipients. The IAM acts as a bridge between IP protocol and ATM protocol environments and handles conversions and encapsulation protocols between environments. An alternate embodiment utilizes an ATM IP Multicast Inserter that embodies similar functions as the IAM but without using multiple virtual circuits. WO 02/43301 A2 is hereby incorporated by reference herein in its entirety.

Another reference, WO 01/95569 A2 filed by Thompson Licensing S.A. and published on Dec. 13, 2001 that is also incorporated by reference herein in its entirety states that the ideal place for effective multicasting is at the edge of the network. Specifically, WO 01/95569 A2 states “The edge device in a Digital Subscriber Line (DSL) network is the Digital Subscriber Line Access Multiplexer (DSLAM). The DSLAM shall have the capabilities of setting up point-to-multipoint connections at the ATM layer (i.e. a multicast connection). By having this function, the DSLAM can replicate data and send it to multiple subscribers on different ports. For a CPE to join a point-to-multipoint ATM virtual circuit, WO 01/95569 A2 states that the CPE sends a request to the network for a multimedia program on an ATM signaling virtual circuit, and that the message is sent to the ATM switch based on ATM signaling virtual circuit.

Yet another reference, U.S. Pat. 6,097,720 discloses a method (see column 2, lines 21-56) for use “in a network having one or more intermediate devices coupled to end stations by respective links, and including a multicast source end station such as a remote access server for an Internet service provider, and a plurality of multicast receiving end stations, such as customer premises equipment CPE, coupled to an intermediate device in the network, the present invention provides a method for distributing multicast distribution functions to the intermediate device. The method comprises establishing point-to-point sessions between the multicast source end station and the plurality of receiving end stations according to a communication protocol such as the PPP. Also, a point-to-point session is established between the multicast source end station and the intermediate device by which the source end station feeds multicast messages to the intermediate device that are directed to a set of multicast groups. The method involves transmitting respective multicast join messages from end stations in the plurality of receiving end stations to the intermediate device. The multicast join messages include information identifying one or more multicast groups for the respective receiving end stations to join. In this way, the intermediate device is enabled to forward multicast messages directed to a particular multicast group in the set of multicast groups to the receiving end stations which have joined the particular multicast group. Finally, the process involves forwarding such multicast messages received at the intermediate station in the point-to-point session between the multicast source and the intermediate device, and directed to a particular multicast group, from the intermediate device to the receiving end stations which have joined the particular multicast group.” U.S. Pat. 6,097,720 is hereby incorporated by reference herein in its entirety.

Instead of video, other types of data (such as web pages) can be supplied to subscribers via the access network. A system for connecting a subscriber between different data service providers, such as America Online, Microsoft Network and corporate local access network (LAN), includes an ATM network connected to the data service providers. In this system, a host digital terminal (HDT) is connected to the ATM network by an ATM permanent virtual circuit (PVC). Each of the ATM PVCs is associated with a corresponding one of the data service providers. The ATM PVCs connect the HDT to the data service providers. The HDT and the data service providers communicate data signals on the ATM PVCs through the ATM network. A customer premises equipment (CPE) data device is connected to the HDT by an ATM PVC over a VDSL line (hereinafter “VDSL PVC”). The CPE device and the HDT communicate data signals on the VDSL PVC. A subscriber personal computer is connected to the CPE device for communicating data signals with the CPE device. The personal computer is operable to generate a channel change request corresponding to a selected one of the data service providers. The HDT, in response to the channel change request, connects the ATM PVC associated with the selected data service provider with the DSL PVC to establish a system PVC connecting the selected data service provider with the personal computer. The selected data service provider and the personal computer communicate the data signals on the system PVC, which acts like a private line therebetween. For more information, see U.S. Pat. No. 6,160,810 that is incorporated by reference herein in its entirety.

Also incorporated by reference herein in their entirety are U.S. patent application 2002/0097728 A1, U.S. patent application 2002/0118638 A1, U.S. patent application 2002/0067730 A1, U.S. patent application 2002/0048275 A1 and U.S. Pat. 6,154,772.

Also incorporated by reference herein in their entirety are the following publications:

An Interoperable End-to-End Broadband Service Architecture over ADSL Systems, published on Jun. 3, 1997 and available over the Internet at:

http://www.intel-u-press.com/usb dbe/Chapter15/ADSL/Overview.pdf;

“Operator Requirements Specification” published Jun. 5, 2002 and available over the Internet at http://www.fs-vdsl.net;

“System Architecture (SA) Specification” published by the FS-VDSL Committee on Jun. 5, 2002 and also available over the Internet at http://www.fs-vdsl.net.

### SUMMARY

In accordance with the invention, an apparatus (called “access multiplexer”) that directly supports the local loop of a public switch telephone network (PSTN), receives only one copy of each of a number of flows of data (e.g. video feeds), for delivery to subscribers, via the local loop. The access multiplexer maintains uni-directional point-to-point logical connections between itself and the subscribers, for the supply of data flows desired by the subscribers. Several embodiments of such an access multiplexer re-use each logical connection again and again as a generic pipe to carry different data flows over a long period of time, in response to subscriber messages for changing the data flows. In one such embodiment, the access multiplexer performs a switching function between the data flows and the logical connections to subscribers, depending on the subscribers' requests.

In certain embodiments, on receipt of each unit of data (such as a data unit of fixed length commonly called “cell”), the access multiplexer identifies zero or more logical connections to subscribers that are to receive the data unit, using one or more numbers (also called “connection identifier”) in the header of the data unit. The connection identifier in each data unit uniquely identifies a flow of data to which the data unit belongs. The access multiplexer uses the connection identifier with an internally-stored mapping, to identify subscribers that are to receive the data flow.

Next, the access multiplexer transmits a copy of the data unit to each subscriber's connection that is identified by the mapping. In transmitting a data unit on a subscriber's connection, the access multiplexer of these embodiments effectively ignores one or more numbers related to an ingress end of the connection (such as the ingress VPI/VCI numbers in case of virtual circuits of the ATM protocol) normally assigned when the subscriber's connection is set up. The access multiplexer repeats the just-described acts for each data unit that is received, thereby to distribute to each subscriber, a data flow that is desired by the subscriber.

When a subscriber wants to change a data flow that is currently being received, the subscriber sends a message towards the access multiplexer. The message is processed to obtain a new connection identifier of a new flow to be sent to the subscriber. Thereafter, the access multiplexer changes its internally-stored mapping, by erasing an association between a previously-used connection identifier and that subscriber's connection, and adding an association between the new connection identifier and that subscriber's connection. Then the access multiplexer continues its processing of each data unit that is received in the above-described manner, but using the new mapping.

The above-described method eliminates tearing down of a subscriber's virtual circuit, followed by setting up of a new virtual circuit to that subscriber, which is required in an alternative method to implement a change in data flow by use of a normal layer-2 (e.g. ATM, frame relay or X.25) switch. Specifically, in the alternative method, identifiers associated with the ingress end of a subscriber's virtual circuit are associated with (e.g. identical to) the connection identifier in the received data unit, and for this reason, the subscriber's virtual circuit needs to be torn down and set up in order to change the data flow. Therefore, to perform the above-described method, a normal layer-2 switch is modified to be responsive to signals from a device (also called “channel control logic”) to simply change internal mapping used to supply data flows to virtual circuits, without affecting the virtual circuits.

Keeping a subscriber's virtual circuit intact and reusing the same virtual circuit for supplying any data flow to the subscriber allows a change in the data flow to be performed very quickly, without the overhead (in time and resources) otherwise involved in tearing down and setting up a virtual circuit. Use of the just-described method in several embodiments permits a subscriber to change a video channel on a television in real time (e.g. from a TV viewer's perspective within 1 second), thereby to allow the subscriber to surf through video channels available for display on a TV, by repeatedly operating a remote control in the normal manner.

Furthermore, only one copy of each video data flow is received by the access multiplexer that is directly connected to the local loop of each subscriber. For at least this reason, an access multiplexer of several embodiments reduces the amount of bandwidth that is otherwise required if video data flows are remotely distributed by an upstream device. Specifically, in the case of remote distribution in the prior art, the upstream device sends to the access multiplexer multiple copies of a video data flow on a corresponding number of virtual circuits that pass through the access multiplexer to a corresponding number of subscribers who are all watching the same video channel.

Therefore, if an embodiment of the access multiplexer is located in a remote terminal, then bandwidth required between the central office and the remote terminal is reduced by sending to the access multiplexer only one copy of each video flow that is currently being watched, and allowing the access multiplexer to replicate data flows as appropriate. In a similar manner, bandwidth between an embodiment of an access multiplexer located in a central office and an upstream device that supplies the video data flows is reduced (assuming subscribers are located sufficiently close to the central office to be directly connected by the local loop to the access multiplexer in the central office).

### BRIEF DESCRIPTION OF THE DRAWINGS

FIG. 1A illustrates, in a high-level block diagram, an access multiplexer in accordance with the invention that receives only one copy of each video flow and provides video services to subscribers in a dialup access environment.

FIG. 1B illustrates, in a high-level flow chart, acts performed in the access multiplexer of FIG. 1A to distribute copies of video flows to various subscribers, and to support channel changing by simply updating an internal mapping.

FIG. 1C illustrates, in a high-level block diagram, the access multiplexer of FIG. 1A changing an internal VC-VC association in response to a subscriber request to change a data flow being sent to the subscriber (in this example the subscriber switches from video channel HBO to video channel NBC).

FIG. 2A illustrates, in a block diagram, one embodiment of the access multiplexer of FIG. 1A that uses virtual circuits (VCs) that terminate in the access multiplexer (“trunk VCs”) and virtual circuits that originate in the access multiplexer (“subscriber VCs”).

FIG. 2B illustrates, in a flow chart, acts performed by the access multiplexer of FIG. 2A.

FIG. 2C illustrates, in a block diagram, the access multiplexer of FIG. 2A changing an internal VC-VC association between a trunk VC and a subscriber VC while keeping these two VCs intact, in response to a subscriber request to switch video channels.

FIG. 2D illustrates a prior art format of a message from a subscriber in conformance with the IGMP protocol, called “membership report” which is sent in response to a membership query (this report message is also called a “join” when sent unsolicited).

FIGS. 3A and 3B illustrate, in a block diagram, change in an internal mapping of the access multiplexer of FIG. 2A in response to a subscriber's request to change a video channel.

FIGS. 4A-4C illustrate an alternative to the method of FIGS. 3A and 3B using normal ATM protocol, wherein a subscriber's VC is torn down and a new VC for the subscriber is created via layer-2 provisioning by an access multiplexer (such as a DSLAM) in response to a layer-3 channel change message from the subscriber.

FIG. 5 illustrates, in a block diagram, the use of various protocol stacks in one implementation of the embodiment illustrated in FIGS. 2A and 2B.

### DETAILED DESCRIPTION

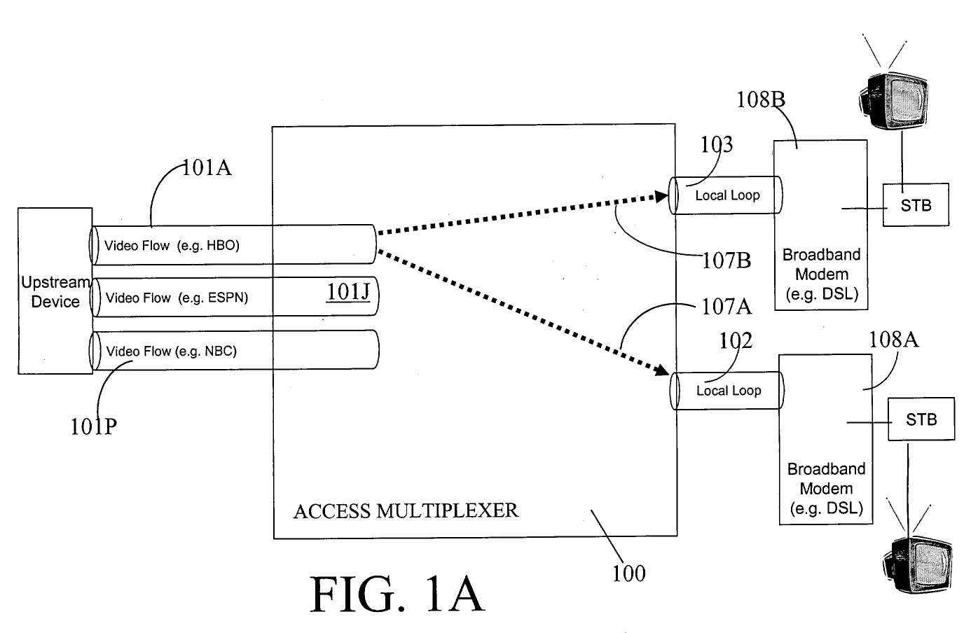

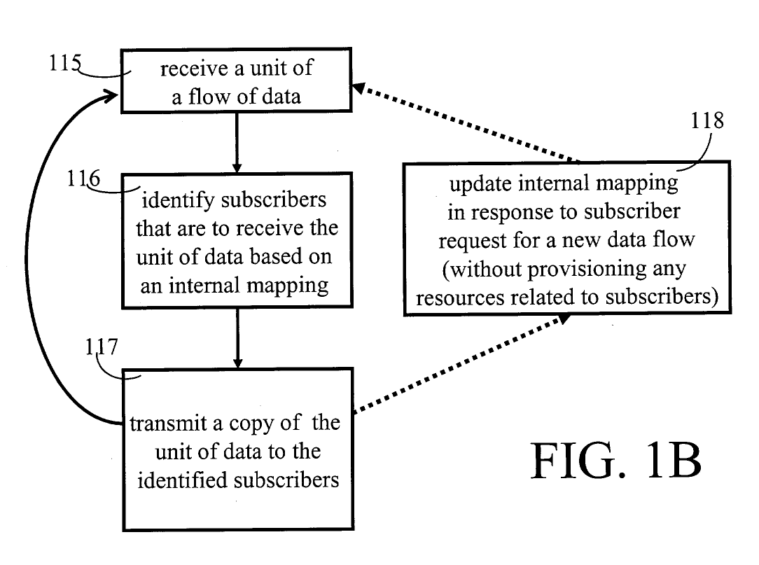

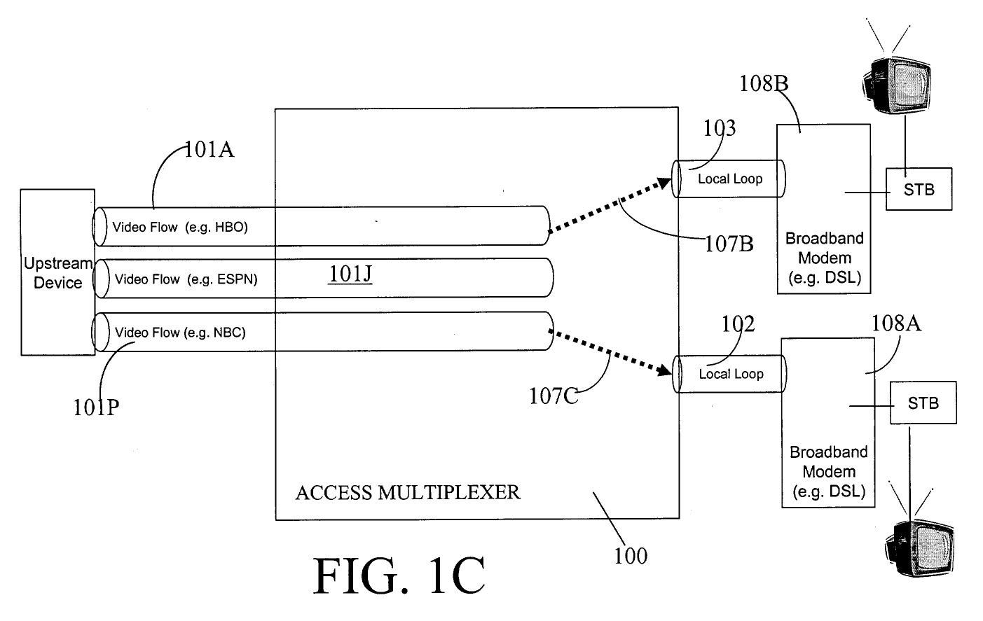

In accordance with the invention, an apparatus 100 (FIG. 1A) that is directly coupled to the local loop 102 of a public switch telephone network (PSTN), receives only one copy of each of a number of flows of data (e.g. video feeds) 101A . . . 101J . . . 101P (wherein A≦J≦P, with P being the total number of flows) over a high-speed link that conforms to a plesiochronous digital hierarchy (such as DS-3 or OC-3). Apparatus 100 internally implements zero or more couplings, such as associations 107A and 107B illustrated in FIG. 1A to supply a copy of a data flow to each subscriber that wishes to receive that particular data flow.

Note that apparatus 100 sends to each subscriber only the data flow requested by that subscriber. If a subscriber requests multiple data flows (e.g. to support a picture-in-picture feature of a television), then apparatus 100 of some embodiments supplies each of the requested data flows (and none of the remaining data flows that may be received by apparatus 100 from an upstream device). For example, when a subscriber wishes to watch a particular video feed, such as HBO, the TV set-top sends a channel request to the apparatus 100, which responds by transmitting only HBO to the set-top.

When multiple subscribers wish to receive the same data flow (e.g. as illustrated in FIG. 1A), apparatus 100 internally makes as many copies of the data units (that form the data flow) as needed (depending on the associations currently being implemented), and supplies the data flow to the individual local loop of each individual subscriber. Apparatus 100 receiving only one copy of a data flow that may be desired by one or more subscribers reduces the bandwidth requirement between an upstream device that is providing the data flow and apparatus 100, even when multiple subscribers are receiving the same data flow.

In FIG. 1A two subscribers watch on their respective televisions a flow of data 101A (e.g. the video channel HBO) that is provided by local loops 102 and 103 to the respective broadband modems 108A and 108B. Each flow of data 101J is transmitted by an upstream device to apparatus 100 in the form of a number of units of data, such as cells that conform to, for example, the asynchronous transfer mode (ATM) protocol. The just-described upstream device can be any communication device, such as a video server, or an ATM switch connected either directly or indirectly to the video server. Moreover, instead of a single upstream device supplying all data flows, it is possible for each data flow to be supplied to apparatus 100 by a different upstream device.

Apparatus 100 receives each unit of the data flow (as per act 115 in FIG. 1B) for distribution to subscribers. Apparatus 100 uses an internal mapping (that represents all associations 107A and 107B) to identify the subscribers that are to receive each data unit (as per act 116 in FIG. 1B). Thereafter, apparatus 100 transmits a copy of the unit of the data flow to each identified subscriber (as per act 117 in FIG. 1B). Next, apparatus 100 returns to act 115 (described above), thereby to repeatedly perform acts 115-117. Note that depending on the implementation, one or more of acts 115-117 may be performed in hardware, and/or performed simultaneous with one another, e.g. on different data units.

Repeated performance of act 116 (FIG. 1B) may be interrupted, e.g. to accommodate a change in the above-described internal mapping that is being used to identify subscribers that are to receive each data unit. Specifically, in response to a request from a subscriber to change a data flow, apparatus 100 updates its internal mapping (as per act 118 in FIG. 1B), to replace an association that was previously used to supply the data flow to the subscriber with a new association that couples the subscriber to the newly-selected data flow. In an example illustrated in FIG. 1C, association 107A has been replaced with association 107C, in response to a subscriber request to receive the video channel NBC. One way to conceptualize such a change in associations is to think of taking an output VC at local loop 102, and disconnecting it from one input data flow (e.g. flow 101A) and connecting it to another input data flow (e.g. flow 101P).

As noted above, associations 107A-107C are implemented by apparatus 100 via an internal mapping (in one embodiment without using any VCs), such as a table or a function, that is used in act 116 described above, to identify subscribers that are to receive a data unit that is currently being processed. In certain embodiments, two copies of the mapping are internally maintained by apparatus 100, with one copy being used in act 116 and another copy being used in act 118 when the two acts are performed simultaneously. On completion of performance of act 116, and before act 116 is repeated with another data unit, pointers to the two mappings are switched, so that the updated mapping is used in the next iteration of act 116.

However, in other embodiments, the mapping may be stored in a dual-port memory, and a single copy of the mapping is simultaneously read independently of being written. In such other embodiments, it is possible that during a channel change, a subscriber may momentarily not receive any data flow e.g. between the time a previously-used association is erased and the time a to-be-used association is written.

Associations 107A-107C provide each data flow that is received in several embodiments of apparatus 100 to zero or more virtual circuits (abbreviated as “VCs”) of a respective number of subscribers. In one embodiment, the VCs to subscribers are point to point permanent virtual circuits (PVCs) in conformance with the ATM protocol, whereas in alternative embodiments, such subscriber VCs can be ATM SVCs, frame relay PVCs or X.25 PVCs. The term PVC refers to a logical connection at layer-2 that is manually provisioned, between a specific source and a specific destination, having a specific bandwidth or quality of service (QOS). In addition, other parameters that may be specified during such manual provisioning include whether or not an adaptation layer is used, and the type of traffic (e.g. constant bit rate or variable bit rate).

In certain embodiments, the subscriber VCs are provisioned to be permanent, e.g. last for a long period of time until the service is terminated (e.g. a period of months or even years), and for this reason referred to as PVCs. However, unless a specific protocol is specifically identified in the following description, the term VC is intended to refer generically to any connection at layer-2 that can be identified by its end points, bandwidth and quality of service (QOS). Note that a PPP connection, although at layer-2, is not covered by the term VC because no bandwidth or QOS is normally specified.

When providing a data flow to more than one VC as may be required by its internal mapping, apparatus 100 makes as many copies of each unit of data as necessary. In a number of embodiments of apparatus 100, associations 107A-107C (that are hereinafter referred to as “VC-VC associations when VCs are being mapped) represent the implementation of the above-described internal mapping in hardware (e.g. by a network processor which may be included in a traffic manager). Updating such an internal mapping (as per act 118 in FIG. 1B) is performed very quickly in these embodiments, without the overhead of tearing down and setting up virtual circuits. Specifically, VC-VC associations 107A-107C are not soft PVCs of the type described in U.S. Pat. No. 6,160,810, and do not require meta signaling switching (such as ATM signaling) as described in, for example, column 4, lines 57-61 of this patent.

Apparatus 100 of certain embodiments performs a number of services (such as narrowband service e.g. plain old telephone service (POTS), and broadband data service e.g. ISDN, ADSL, Centrex, and/or VDSL) that are normally performed by a local loop interface of a local exchange carrier (e.g. CLEC or ILEC). For this reason, apparatus 100 may also be referred to as an access multiplexer (e.g. a Digital Subscriber Line Access Multiplexer (“DSLAM”)), access concentrator, access hub, access node, access platform, access aggregator, multi-service access switch, broadband Digital Loop Carrier (DLC). Furthermore, although described in terms of a telephony local loop, other embodiments may provide interfaces to a wireless local loop (e.g. in the form of a Wireless Base Station).

A device that is used on the subscriber's premises to interface to apparatus 100 depends on the type of technology used by apparatus 100. For example, a DSL modem is used in case of a DSLAM, and a broadband fixed wireless point to multipoint CPE (customer premises equipment) in case of a broadband fixed wireless point to multipoint base station. In the following description, apparatus 100 is referred to as an access multiplexer, although any of the just-described terms may be used when referring to such an apparatus. Moreover, the term “broadband modem” is used in a generic manner to refer to devices that interface to apparatus 100.

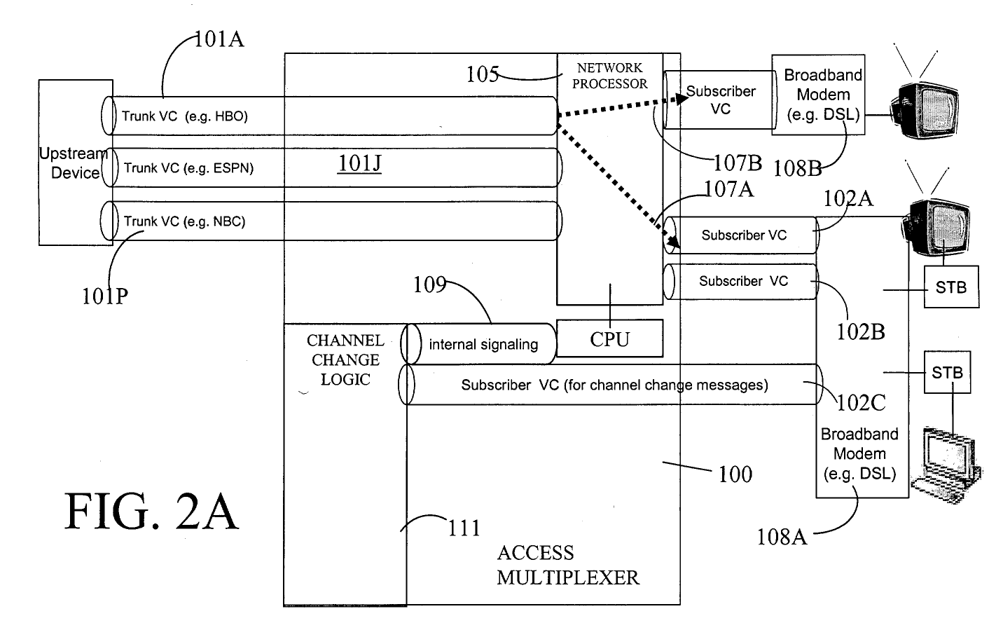

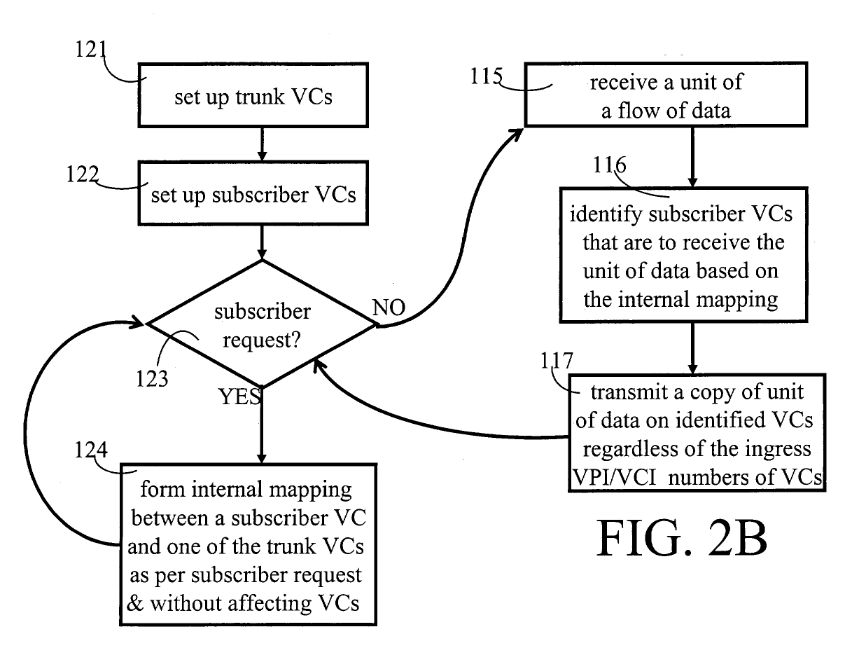

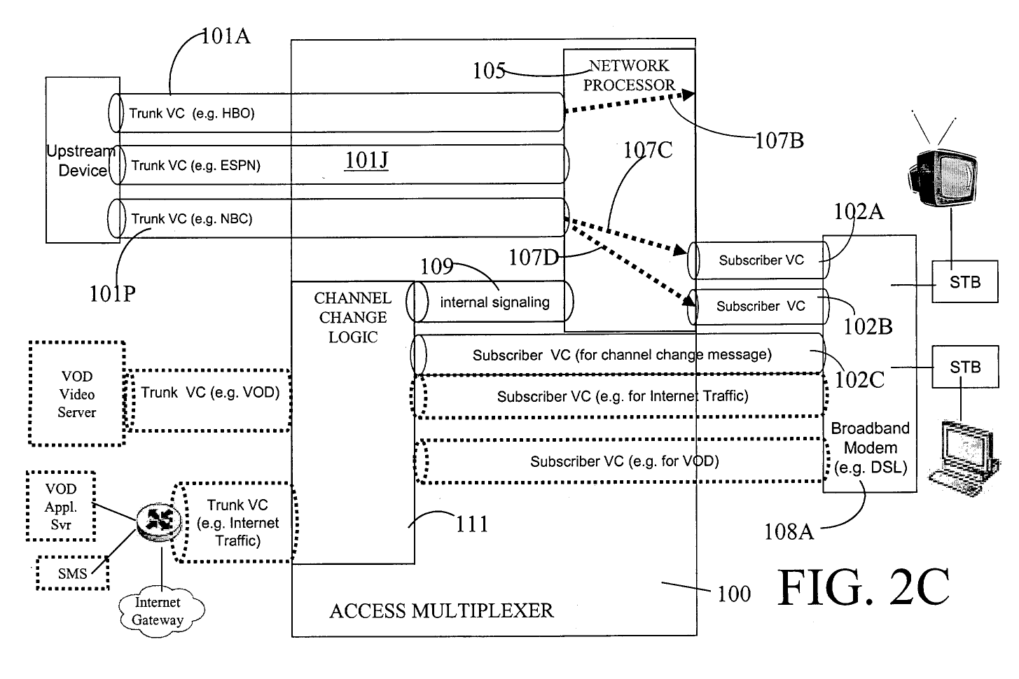

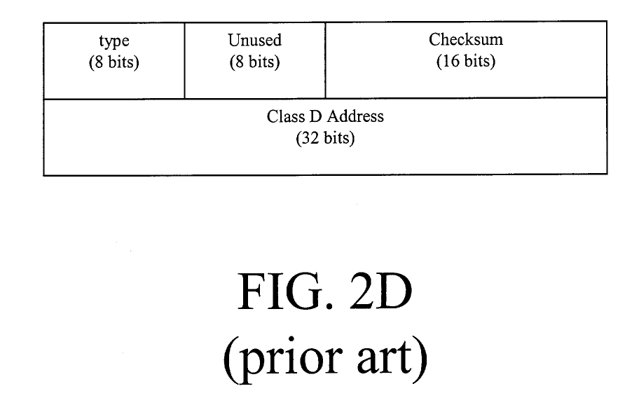

FIG. 2A illustrates certain embodiments in which a number of VCs (called “trunk VCs”) 101A-101P are set up to carry data flows over a high speed link (e.g. a dedicated T-1 line, T-3 line, DS-3 line or OC-3 line) from one or more upstream devices to access multiplexer 100 (as per act 121 in FIG. 2B). Note that such a high speed link may carry signals at any speed conforming to a plesiochronous digital hierarchy, such as SONET (an abbreviation for “synchronous optical network”) or SDH (an abbreviation for “synchronous digital hierarchy”).

In such embodiments, a number of additional VCs (called “subscriber VCs”) are set up to carry data flows from access multiplexer 100 to the respective subscribers (as per act 122 in FIG. 2B). For example, two subscriber VCs 102A and 102B (FIG. 2A) may be formed over a single digital subscriber line (DSL) to provide two data flows to the respective set top boxes (both of which are serviced by the same modem 108A in this example).

Furthermore, it is to be understood that the number of data flows that can be formed over a single local loop using a broadband protocol such as asynchronous DSL (ADSL) or very high speed DSL (VDSL) depends on the bandwidth required for each data flow and the bandwidth supported by the local loop. The above-described local loop between access platform 100 and the set-top boxes is not limited to a telephone line (i.e. copper wire twisted pair) and instead can be any broadband link, such as, for example, an Ethernet connection (e.g. implemented over a fiber optic link, supported by FTTH), or even a broadband wireless link.

After the trunk and subscriber VCs are set up, whenever a subscriber request is received (as per act 123 in FIG. 2B), access multiplexer 100 forms an association (as per act 124) which is represented in its internal mapping, between that subscriber's VC and a trunk VC that carries the data flow being requested. Furthermore, access multiplexer 100 of these embodiments implements acts 115-117 while using VCs and such acts can be performed sequentially as illustrated in FIG. 2B or alternatively in parallel, e.g. when implemented in hardware. In the example illustrated in FIG. 2C, a subscriber that is using the television is watching the video channel HBO, while another subscriber that is using the personal computer is watching the video channel NBC, and the respective video feeds are delivered via VC-VC associations 107A and 107D in network processor 105 (that is included in a traffic manager).

The following description refers to use of the ATM protocol in an exemplary embodiment illustrated in FIG. 2A, although other protocols may be used in other embodiments. In the exemplary embodiment, on receipt of each cell, access multiplexer 100 identifies zero or more virtual circuits of subscribers that are to receive the cell, using a VPI/VCI number in the cell and the internal mapping which associates the cell VPI/VCI numbers with the subscriber VCs. Thereafter, access multiplexer 100 transmits a copy of the cell on each subscriber VC that is identified, wherein identification of each subscriber VC provides at least an output VPI/VCI number and an output port (to which the subscriber is connected by the local loop).

In the example illustrated in FIG. 2A, on receipt of a cell carrying data of the video channel HBO, a network processor 105 that is included in access multiplexer 100 extracts a VPI/VCI number from the header of the received cell and uses this extracted number with its internal mapping (which may be implemented, for example, in the form of a table) to implement two VC-VC associations 107A and 107B to the respective modems 108A and 108B (see FIG. 2A).

In this example, VC-VC associations 107A and 107B identify two ports to which the respective modems 108A and 108B are connected (by local loops). Note that each port is identified globally within the entire system, so that a port's identity may include (depending on the hardware architecture): a node identifier, a shelf identifier (local to the node), a slot identifier (local to the shelf), and a port identifier (local to a line card) in the shelf. Note that an STS number may also be included in the port's identity, depending on the embodiment.

The mapping for VC-VC associations 107A and 107B also identifies the egress VPI/VCI numbers that are to be inserted (in some embodiments) in each cell to be transmitted on the respective subscriber VCs to modems 108A and 108B. Next, in several embodiments, network processor 105 enqueues a copy of the cell (after appropriately updating the cell header) in a queue associated with each of the respective ports, for transmission through a switch fabric, to modems 108A and 108B. Network processor 105 repeats the just-described acts for each cell that is received, thereby to distribute to each subscriber, a data flow that is desired by the subscriber.

In addition to the above-described network processor 105, access multiplexer 100 of the exemplary embodiment also includes logic (hereinafter “channel change logic”) 111 that receives the subscriber requests to change channels, and generates appropriate signals for the network processor 105 to change its internal mapping in an appropriate manner to implement the channel change desired by the subscriber. Specifically, when a subscriber wants to change the channel being received, the subscriber's set-top box (abbreviated as “STB”) sends a message to access multiplexer 100. Note that the above-described subscriber VCs 102A and 102B are uni-directional, point-to-point virtual circuits, and the just-described message is sent over another subscriber VC 102C that carries cells from modem 108A to access multiplexer 100.

In the exemplary embodiment, the message (which carries therein the subscriber's request to change the channel) has a format equivalent to layer-3 of the OSI reference model, e.g. a packet (also called message) that conforms to the Internet Protocol (IP), such as Internet Group Management Protocol (IGMP). Channel change logic 111 contains functionality to parse the message, to identify a new VPI/VCI number of a newly-selected data flow to be sent to the subscriber. In addition, channel change logic 111 identifies the identity of the port to which the subscriber is connected (by the local loop).

Thereafter, channel change logic 111 generates one or more signals for network processor 105 to change the mapping, and sends the signals via a bus 109. In some embodiments, logic 111 and processor 105 are located within a single chassis, and in such embodiments bus 109 includes a bus in the backplane of the chassis that implements access multiplexer 100. In other embodiments, logic 111 and processor 105 are located within a single cabinet but in different chassis and in such embodiments, bus 109 includes an inter-shelf bus. In one such embodiment, the signals between logic 111 and processor 105 are sent to a central switching unit that in turn sends the signals to a line unit containing network processor 105. In one specific implementation of this embodiment, a forwarding lookup is performed by software in each of a number of central processing units in each of a number of line units.

In still other embodiments, logic 111 and processor 105 are located at different locations (e.g. logic 111 may be located in the central office and processor 105 may be located in the remote terminal), and in such a case bus 109 includes a communication link between the two locations (e.g. and may be implemented via a virtual circuit over the link). Note, however, that a virtual circuit may be used even in embodiments in which logic 111 and processor 105 are located in the same cabinet, or even in the same chassis. Use of an ATM VC (or other layer-2 connection) to transfer signals between logic 111 and processor 105 improves the speed with which a channel change can be implemented, e.g. if cells carrying the signals pass through intermediate line units without the need for software forwarding lookup in a central processing unit of each line unit.

Moreover, in one embodiment, bus 109 supplies the signals provided by logic 111 to a central processing unit (labeled “CPU” in FIG. 2A), and software in the CPU provides appropriate instructions to the network processor (e.g. to break an existing VC-VC association and make a new VC-VC association). For clarity, the just-described CPU is not shown in FIG. 2C (wherein bus 109 is shown coupled directly to the network processor). Such an embodiment may be alternatively implemented, e.g. if network processor can be configured (e.g. by software or by custom hardware design) to understand the signals generated by logic 111.

In some embodiments, a first signal on bus 109 from logic 111 to processor 105 indicates an existing VC-VC association 107A is to be broken, and a second signal therebetween indicates a new VC-VC association 107C is to be made (FIG. 2C). The format of these two signals is as follows: identifiers of each of two VCs (a trunk VC and a subscriber VC), and whether a VC-VC association there between is to be broken or made.

On receipt of each such signal, network processor 105 changes entries in its table(s) without regard to an input VPI/VCI number of the subscriber's VC. Thereafter, network processor 105 continues to repeatedly process each cell that is received, in the above-described manner, but using the new mapping. All subscriber VCs are kept intact during the entirety of the above-described method (i.e. during cell processing, as well as during the channel change).

Moreover, VC-VC associations 107A-107C are changed by simply updating a mapping used by network processor 105, without performing any acts normally associated with provisioning a virtual circuit, such as tearing down and setting up permanent virtual circuits (PVCs) of the ATM protocol. To avoid provisioning, the channel change illustrated in FIG. 2C is implemented by simply updating the network processor's mapping (e.g. without changing the amount of bandwidth associated therewith and/or the type of traffic to be carried thereby), resulting in a channel change in real time from the subscriber's perspective (e.g. in less than 1 second).

Therefore, during cell processing as well as during channel changing, none of trunk VCs 101A-101P and none of subscriber VCs 102A-102C is torn down or set up. Instead, a network processor 105 initially connects the ingress end of subscriber VC 102A to the egress end of trunk VC 101A, thereby to form VC-VC association 107A. Subsequently, on receipt of the channel change message, network processor 105 breaks this VC-VC association 107A and instead connects the ingress end of subscriber VC 102A to the egress end of trunk VC 101P, thereby to form VC-VC association 107C.

In forming the just-described VC-VC associations 107A and 107C, network processor 105 does not take into account a VPI/VCI number at the ingress end of subscriber VC 102A. Therefore, each existing subscriber VC is re-used again and again as a generic pipe over a long period of time to carry different data flows (i.e. cells with different VPI/VCI numbers prior to transmission over the VC), in response to each channel change message being processed. Each channel change message only affects the mapping in network processor 105, but does not affect trunk VCs 101A-101P and/or subscriber VCs 102A-102C.

Use of a mapping as described above enables network processor 105 to breakup system-wide VCs that would otherwise simply pass through the access multiplexer (i.e. originate in an upstream device and end in a subscriber's modem). The system-wide VCs normally require bandwidth to be allocated between the access multiplexer and the upstream device for every set-top box (so that the bandwidth per VC is multiplied by the number of set-top boxes being supported). In contrast, by use of an internal mapping as described above, network processor 105 provides any data flow to any subscriber VC. Therefore, network processor 105 provides VC-level “cross-connect” functionality, between trunk VCs that end in the access multiplexer 100 and subscriber VCs that originate in the access multiplexer 100.

Although in the exemplary embodiment, channel change logic 111 is located inside access multiplexer 100, as noted above such logic can be located inside another device that is upstream of the access multiplexer. Use of a channel change logic 111 of the type described above eliminates the need for a router, thereby resulting in savings in cost (due to less hardware) and increased speed in implementing a channel change. Furthermore, since channel change logic 111 contains functionality to parse the headers of IP packets, the above-described subscriber VC 102C can also be used for carrying other IP traffic, e.g. between a personal computer and the Internet.

In such a case, channel change logic 111 is also coupled to an external router by a trunk VC that carries IP traffic from all subscribers that are serviced by channel change logic 111. In this embodiment, channel change logic 111 contains functionality to filter out channel change (e.g. IGMP) packets from the rest of IP traffic which is forwarded to the router (unless IP packets are directed from one subscriber to another subscriber both of whom are serviced by the same channel change logic 111 in which case logic 111 performs a routing function there between).

In some embodiments, channel change requests from subscribers may be in layer-3 packets having the format illustrated in FIG. 2D which is described in RFC 2236, version 2 published by IETF in November 1997 that is incorporated by reference herein in its entirety. In such embodiments, if messages in the format defined by RFC 2236, version 1 are received, a channel change is not done and instead, a count is incremented for use by the service provider (also called LEC). One such embodiment uses the following data structure and the following enumerated data types to parse channel change requests:

// Structure for IGMP data
typedef struct tIgmpData

| | | |
|---|---|---|
| { | | |
| U8 | Type; | // Type of packet |
| U8 | MaxRespTime; | // Maximum response time |
| U16 | Checksum; | // One's complement checksum |
| U32 | Group; | // The multicast group |
| } tIgmpData; | | |

// Packet types being used (see type field above)

| | | |
|---|---|---|
| #define _IgmpPktTypeReport_ | 0x16 | // Report message |
| #define _IgmpPktTypeLeave_ | 0x17 | // Leave message |
| #define _IgmpPktTypeQuery_ | 0x11 | // Query message |

| | |
|---|---|
| #define _IgmpPktTypeV1Report_ 0x12 | // Version one report message |

In the above data structure, the field “Group” indicates an IP multicast address which identifies the data flow (e.g. the channel number of a video data flow) that is being requested.

A subscriber (say subscriber S) may send two IGMP messages, when switching data flows. A first message (also referred to as “leave message”) to ask that a currently-supplied data flow (say channel A) be stopped and a second message (also referred to as “report message”) to ask that a newly-selected data flow (say channel B) be provided. On receipt of the first message, channel change logic 111 does not immediately stop transmission of channel A to subscriber S. Instead, channel change logic 111 determines that there is no other subscriber at the other end of the local loop (to which subscriber S is connected) that desires to receive the same data flow (e.g. by sending out a Group Specific Query message to the multicast address of subscriber S).

Each subscriber on this local loop responds to the Group Specific Query message with an IGMP message indicating the channel that the subscriber desires to watch, unless another subscriber has already responded identifying the same channel. Depending on the implementation, logic 111 may send the Group Specific Query message multiple times over the same local loop, and may wait for a significant period of time (e.g. 100 milliseconds after each message) before determining the next course of action. Note that the just-described waiting period is provisionable in some embodiments. If there is no other subscriber that needs channel A, then logic 111 stops transmission of channel A and only at this point starts transmission of channel B to subscriber S.

On the other hand, if there is at least one subscriber other than subscriber S that needs channel A, then transmission of channel A is not stopped and instead channel B is also transmitted (over the same local loop) to subscriber S. Multiple subscribers may receive correspondingly different video flows if the broadband modem supports multiple virtual circuits (of the appropriate bandwidth) over the same local loop. For example, up to two video feeds (each requiring bandwidth of 3.6 Mbps) may be provided by an access multiplexer 100 to each broadband modem that provides 8 Mbps of bandwidth over the local loop based on ADSL technology. However, the invention is not limited to two video feeds, because three or more video feeds may be supported if the bandwidth over the local loop is greater. During the above-described change of data flows, channel change logic 111 appropriately updates values in its internal mapping, so that the requested data flow B is provided to the subscriber S in the manner described above.

In an alternative embodiment, channel change logic 111 implements a faster process for channel changing if the subscribers do not conform to the IGMP protocol in one respect: each subscriber sends out a response to the the Group Specific Query message regardless of any other subscriber's response (on the same local loop). Such a modified IGMP protocol allows access multiplexer 100 to maintain internally a count (or a list of identities) of the subscribers on a local loop that are currently watching the same channel (e.g. channel A) that is updated frequently (e.g. in real time). Specifically, logic 111 sends out IGMP packets (also referred to as “queries”) at regular intervals to see if any subscribers continue to belong to each multicast group whose data flow is currently being supplied to the local loop of subscriber S. In such an embodiment, a data flow is stopped in other circumstances as well, e.g. if logic 111 does not receive a response to the periodic query.

Moreover, in the alternative embodiment described above, any IGMP packets that are sent in response by the subscribers are used to track membership (e.g. by incrementing/decrementing a count) for each multicast group. In such an embodiment, on receipt of the above-described first message, logic 111 knows immediately (based on the above-described internally maintained information) as to whether or not any other subscriber on a given port is watching channel A and if no other subscriber on that port is watching, data flow for channel A to subscriber S is stopped followed immediately by transmission of the data flow for channel B.

Instead of using a single subscriber VC 102C to carry both generic IP packets as well as channel change messages, in other embodiments, an additional subscriber VC may be used just for IP traffic. Moreover, a channel change logic 111 that contains routing functionality (as described above) can be used to provide support for video on demand (VOD), wherein VOD traffic may be carried either on the same subscriber VC or on another subscriber VC, as would be apparent to the skilled artisan in view of this disclosure.

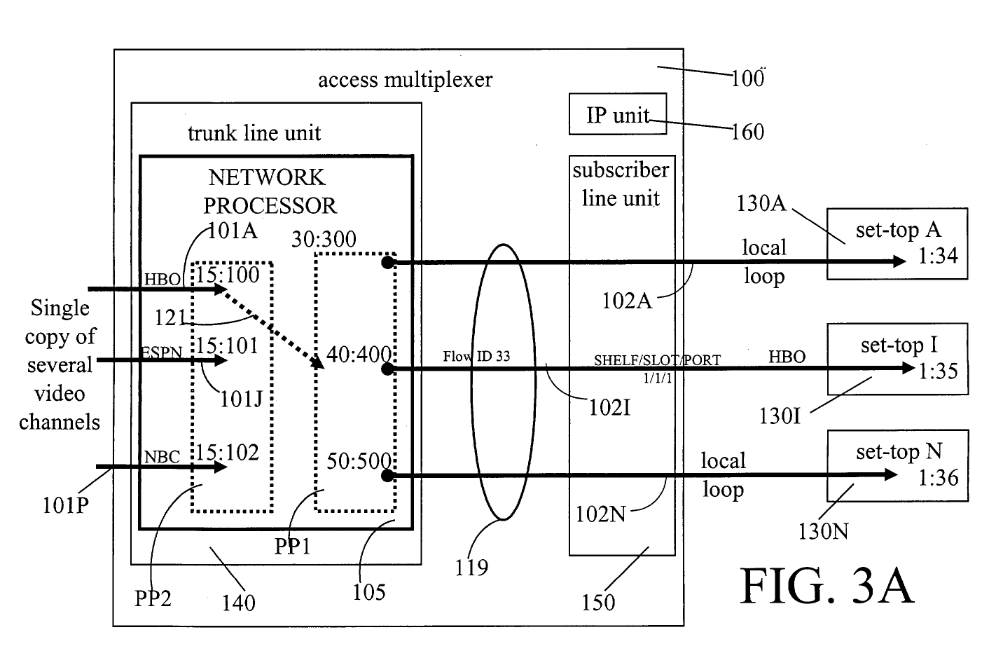

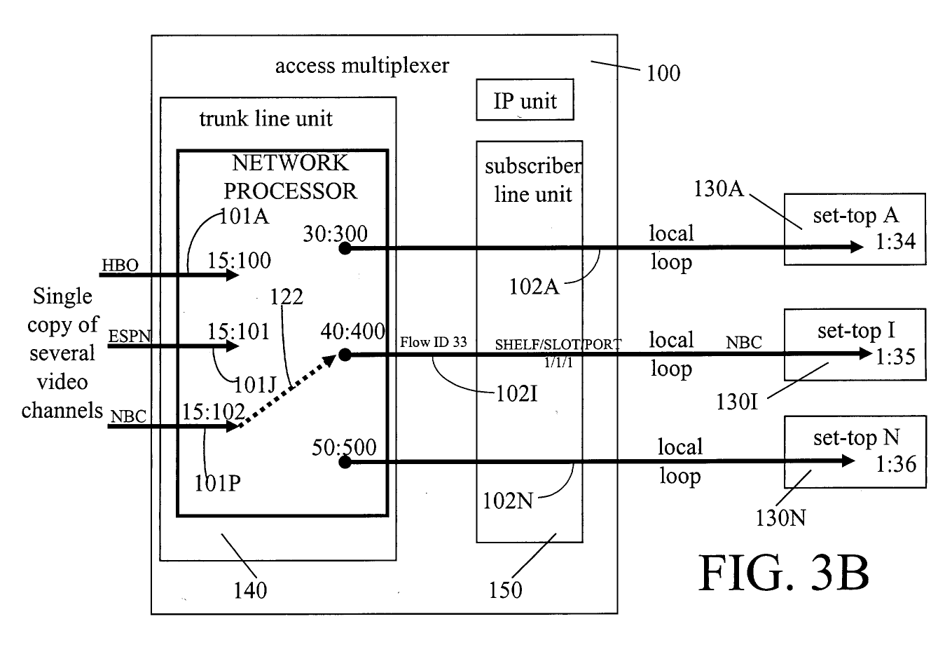

In an exemplary implementation, hardware for the above-described channel change logic 111 that performs a routing function (at layer-3) is organized into a unit (also called “IP unit”) 160 (FIG. 3A) that is separate and distinct from another unit (hereinafter “trunk line unit”) 140 that interfaces to one or more high speed trunk line(s) connected to one or more upstream device(s). Units 140 and 160 (FIG. 3A) are also separate and distinct from yet another unit (hereinafter “subscriber line unit”) 150 that interfaces to one or more local loops of subscriber(s). Each of units 140 and 160 perform only layer-2 functions in several embodiments.

In one specific implementation, each of units 140, 150 and 160 (individually implemented as a card) is housed in a slot of a single chassis in an access multiplexer 100, and unit 140 has a single port in conformance with SONET protocol or SDH protocol, whereas unit 150 has 24 ports in conformance with DSL. Depending on the implementation, a single IP unit 160 may service a number of line units not only in the single chassis but also in a number of other chassis in a single cabinet, and also a number of chassis in other cabinets. In the example illustrated in FIG. 3A, each of units 140, 150 and 160 are held in slots of a chassis, and communicate via a backplane in the chassis.

In one such implementation, each access multiplexer 100 sets up virtual circuits (hereinafter “trunk VCs”) 101A-101P that have an ingress end in an upstream device that is coupled to access multiplexer 100 by a SONET or SDH ring. For example, trunk VCs 101A-101P may enter access multiplexer 100 via a single SONET port of speed OC-12, and they have an egress end inside trunk line unit 140. For example trunk VCs 101A, 101J and 101P may respectively have egress end points with the following VPI/VCI numbers, inside trunk line unit 140: 15:100, 15:101 and 15:102, as illustrated in FIG. 3A.

In this embodiment, cells for trunk VCs 101A-101P enter access multiplexer 100 from an upstream device, at one or more ports (e.g. an OC-12 port that conforms to SONET) in trunk line unit 140. Therefore, trunk VCs 101A-101P originate at such a real port, but do not pass through access multiplexer 100 to the subscribers. Instead, network processor 105 within trunk line unit 140 performs one or more functions and signaling related to ending each of trunk VCs 101A-101P within the network processor. Such VC ending functionality within network processor 105 is also referred to herein as a “pseudo port.”

As used herein, the term “pseudo port” refers to an interface that is provided to software and/or hardware entities in the access multiplexer (e.g. configuration software in the CPU) that require each VC to have two ports, so that the design of such entities need not be changed. From the perspective of such other entities, a pseudo port can originate, receive and pass through cells to other ports (which may be either real ports or pseudo ports). The pseudo port provides support for standards-based data flows in the required format (e.g. as per the ATM protocol or frame relay). Therefore, a pseudo port in trunk line unit 140 appears as a real port to other software and hardware entities in access multiplexer 100. However, no real port of the trunk line unit is in fact associated with such a pseudo port, unlike prior art logical ports (e.g. available in the Agere “RSP”) that always map to real ports.

The just-described pseudo port can be used to terminate any number of trunk VCs originating in any real port of the trunk line unit, without any limits (such as port capacity or speed) that are normally imposed for real ports. From the perspective of a pseudo port, there are no bandwidth limits in terminating VCs at the pseudo port if the VCs originate within the same line unit. However, if the VCs being terminated originate in another line unit, then bandwidth of the bus in the backplane of the chassis that holds the line units needs to be taken into account. For this reason, trunk line unit 140 implements two pseudo ports: (a) a pseudo port “PP2” for VCs that start or end at ports entirely internal to the line unit and (b) another pseudo port “PP1” for VCs that start or end at ports in another line unit for which bus bandwidth needs to be accounted for.

In the above-described example, trunk VCs 101A-101P (FIG. 3A) originate at one or more real ports and terminate at pseudo port PP2 (which is also called “egress pseudo port”). From the perspective of a real port, its normal limits are effectuated when provisioning VCs, e.g. if there is a limit on the number of VCs or on the amount of bandwidth at a real port, such limits prevent setting up an unlimited number of VCs from that real port even if the VCs are to end in a pseudo port.

Furthermore, each of subscriber VCs 102A-102N has an ingress end point in network processor 105, with the following VPI/VCI numbers inside trunk line unit 140, namely 30:300, 40:400, and 50:500. In this case, VCs 102A-102N do not originate in the upstream device and pass through access multiplexer 100. Instead, network processor 105 within trunk line unit 140 performs one or more functions related to originating a subscriber VC, such as end-point switching. Depending on the implementation, additional functionality may be provided, e.g. (1) in case one or more ATM SVCs are to be set up, the end-point functionality may support ATM signaling expected by the other end of the VCs, in conformance with the ATM protocol, and (2) in case one or more ATM PVCs are set up as bidirectional PVCs, the end-point functionality may support, for example ping. Note that in case of unidirectional ATM PVCs that are used in some embodiments of the type described herein, there is no additional functionality needed at the end point (other than to support normal switching of cells). Such VC end-point functionality for originating a VC may be implemented in, for example, the above-described pseudo port PP1 (also called “ingress pseudo port”) within network processor 105.

In some embodiments, each trunk line unit in access multiplexer 100 has only one egress pseudo port and only one ingress pseudo port, regardless of the number of real ports. Therefore, a trunk line unit that has four OC-12 ports has only one egress pseudo port for coupling to (e.g. receive data flows from) all of the four ports, whereas another trunk line unit that has sixteen OC-3 ports also has only one egress pseudo port for coupling to all sixteen ports. Furthermore, in these embodiments, each ingress pseudo port in each trunk line unit can be coupled (e.g. provide data flows) to every real port on every subscriber line unit in a shelf of the access multiplexer 100. In one such embodiment, VCs from a trunk line unit in one shelf are not set up to provide data flows to subscriber line units in another shelf.

Note that subscriber VCs 102A-102N (FIG. 3A) may pass through a bus in a backplane between multiple slots or a bus between chassis (not shown in FIG. 3A) within access multiplexer 100, through one or more subscriber line unit(s) 150 (see FIG. 3A) within access multiplexer 100, through the subscribers' local loop, into a broadband modem in the subscribers' premises. The modem in which these VCs end may provide end-point signaling needed for ending a VC, depending on the embodiment. Provisioning of a subscriber VC that originates at the ingress pseudo port requires bandwidth to be reserved on bus 119 (FIG. 3A) between the trunk and subscriber line units, whereas provisioning a trunk VC that ends at the egress pseudo port does not require bandwidth on bus 119.

Access multiplexer 100 may be configured in certain embodiments to automatically allocate bandwidth whenever a VC is set up to use the ingress pseudo port. Note that the egress pseudo port and the ingress pseudo port only provide layer-2 functionality and do not provide functionality at a higher layer (e.g. functionality of a HTTP port). As noted above, layer-3 functionality (e.g. for parsing headers of IP packets and routing the IP packets) may be provided within another unit, namely IP unit 160 (FIG. 3A). Although pseudo ports are used in some embodiments (as shown by dashed lines in FIG. 3A), in other embodiments, network processor 105 ends and originates the trunk and subscriber VCs respectively, at a real port, such as a SONET port on which video flows are received from the upstream device.

In embodiments that use pseudo ports, a local exchange carrier (LEC) that operates apparatus 100 may set up subscriber VCs by specifying the egress end in the normal manner, and the ingress end also in the normal manner but with one exception: instead of a real port number, the code “PP1” is used to identify the ingress pseudo port. In a similar manner, trunk VCs are set up by specifying the ingress end in the normal manner, and the egress end is specified by use of the code “PP2” instead of a real port number. A network processor 105 is configured to automatically allocate bandwidth on a bus to the subscriber ports in case a VC being set up is to start at port PP1, but not when the VC ends at port PP2. In alternative embodiments that do not use pseudo ports, a command to set up a VC may specify an additional parameter, e.g. the word “backplane”, which may be used by network processor 105 to reserve or not reserve bandwidth.

In this manner, the above-described subscriber virtual circuit 102I is used unchanged, and as a generic pipe to initially supply a data flow received on trunk virtual circuit 101A (as per FIG. 3A), and thereafter supply another data flow received on trunk virtual circuit 101J (FIG. 3B). The change in data flow is implemented simply by instructing network processor 105 to change its mapping that initially implements VC-VC association 121 and later implements VC-VC association 122. VC-VC associations 121 and 122 represent switching decisions made by network processor 105, based on the internal mapping and without regard to the ingress VPI/VCI of the subscriber VCs 102A-102N.

For example, initially a VC-VC association 121 provides cells having VPI/VCI numbers 15:100 to VC 102I that has ingress VPI/VCI numbers 40:400, and later when this VC-VC association is replaced, cells having VPI/VCI numbers 15:101 are provided to the same VC 102I. In some embodiments, the internal mapping in network processor 105 does not contain the ingress VPI/VCI numbers of subscriber VCs, thereby to implement the above-described VC-VC associations without matching VPI/VCI numbers as in normal ATM switching (which is described next). In this example, the VPI/VCI numbers 1:35 are inserted into the header of each cell being provided on VC 102I (FIG. 3A). Note that instead of inserting the egress VPI/VCI number 1:35 of VC 102I, the previous VPI/VCI number 15:101 may be left undisturbed in an alternative embodiment, when providing the cell on VC 102I to any subscriber VC, e.g. to conform to the FS-VDSL standard.

In some embodiments, the above-described mapping is implemented by a table which uses unique numbers (called “handles”) to identify the subscriber VCs. Use of such handles to identify subscriber VCs eliminates use of the ingress VPI/VCI numbers of subscriber VCs in making the switching decision on receipt of a cell. In one embodiment, when a cell is received, that cell's VPI/VCI numbers are used as key to look up the table and to retrieve in a single operation the egress VPI/VCI numbers of the subscriber VC, the ingress port of the subscriber VC and the handle that uniquely identifies the subscriber VC. Note that instead of using a cell's VPI/VCI numbers to look up the table, any number that uniquely identifies a flow of cells being received may be used in alternative embodiments. For example, a handle that uniquely identifies each trunk VC may be used to look up the table.

In the example illustrated in FIG. 3A, when a cell containing VPI/VCI of 15/100 is received on trunk VC 101A, a table lookup may provide a subscriber VC's handle (e.g. the value 723) that uniquely identifies subscriber VC 102I. It is to be understood that if hundreds of subscribers are watching the same channel, the just-described table lookup yields the handles of virtual circuits (VCs) to each of the hundreds of subscribers. Therefore, a copy of the received cell is sent on each of VCs, using the identified handles, and the network processor 105 inserts into a header of each copy of the cell the egress VPI/VCI number of the subscriber VC.

When the channel change happens, a currently-in-use row in a table containing the handle value 723 of subscriber VC 102I is changed (by erasing this handle value), and a to-be-used row is located by use of the newly-selected flow's VPI/VCI of value 15/101 as the key. This to-be-used row is then updated to add subscriber VC 102I (by inserting the handle value 723), to zero or more subscriber VCs that may already be receiving the newly-selected flow. Note that the just-described changes are limited to just the tables used in switching incoming cells to one or more outgoing VCs.

In the just-described example, from this point in time when a cell with a VPI/VCI of 15/101 arrives, the table lookup identifies handle value 723, thereby to identify subscriber VC 102I as the recipient of this cell. Therefore, a change in data flows is implemented while keeping intact the existing subscriber VC 102I, simply by allowing ingress VPI/VCI numbers of a subscriber VC to not match a cell's VPI/VCI numbers when performing cell switching.

Although several embodiments use a table that identifies each subscriber VC using a unique handle, use of handles is not required in other embodiments. For example, in several other embodiments, the tables are used to identify the egress VPI/VCI numbers of subscriber VCs and the egress port numbers, and this information is used to transmit the incoming cell to the subscriber VCs. In such other embodiments, processing of cells is identical to the cell processing that is performed in normal ATM, except that the table is set up differently (i.e. the cell's VPI/VCI number is used instead of the ingress VPI/VCI numbers of the subscriber VC, to permit a mismatch there between).

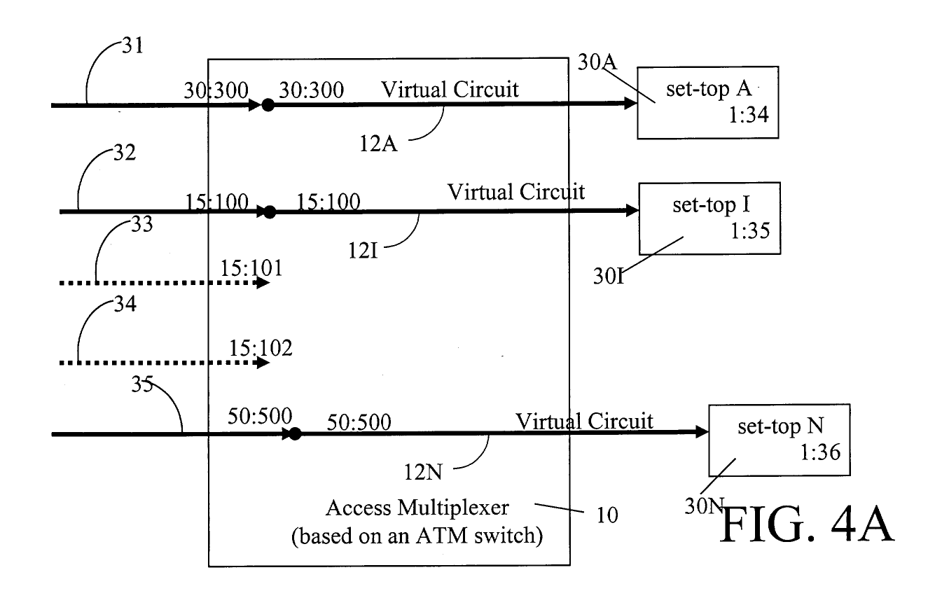

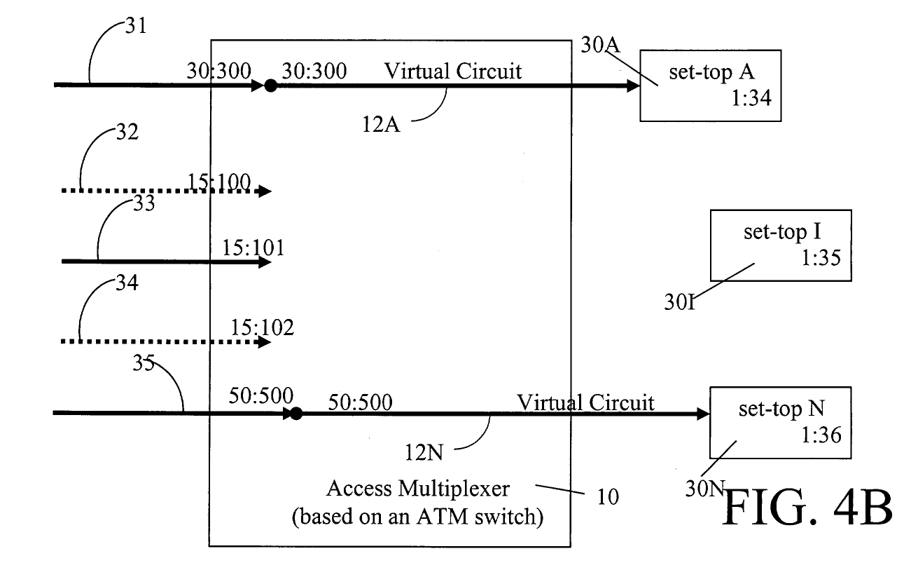

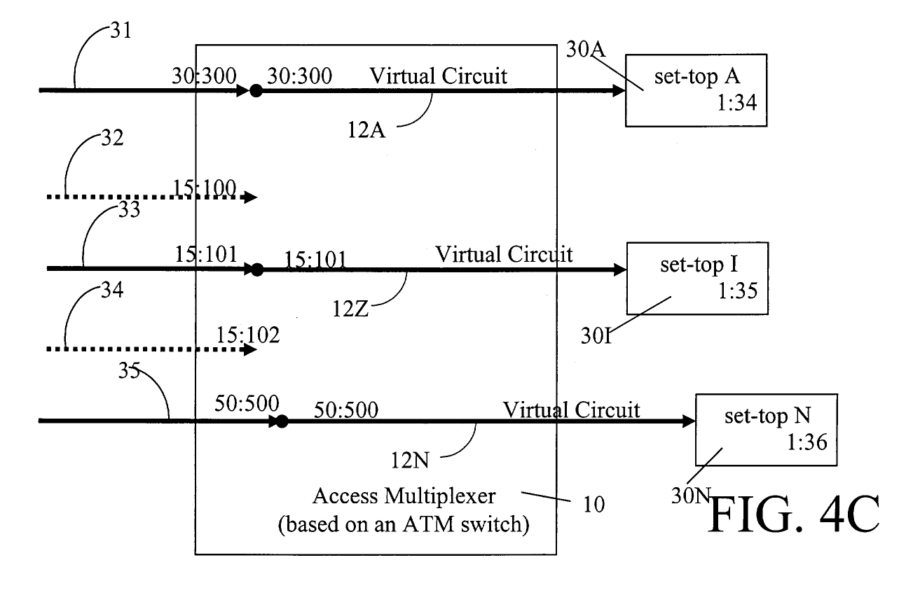

Although in some embodiments permitting the above-described mismatch in VPI/VCI numbers is a critical aspect, in alternative embodiments of an access multiplexer such mismatch may not be permitted as in the case of normal ATM switching. Specifically, normal ATM does not allow cells having a given VPI/VCI number combination to be transmitted on a VC whose ingress VPI/VCI numbers are different. However, normal ATM switching may be used in an alternative embodiment of an access multiplexer 10 (FIG. 4A) that can provide data flows via local loops to set-top boxes 30A-30N, by tearing down and setting up virtual circuits (e.g if this is the only mechanism available to update a table of the type described above).

Depending on the implementation of alternative embodiments (based on normal ATM switching), the virtual circuits that are set up and torn down can be, for example, switched virtual circuits (SVCs), or soft permanent virtual circuits (soft PVCs). For example, in FIG. 4A, virtual circuits 12A, 12I and 12N carry data flows 31, 32 and 35 respectively, e.g. because the ATM switch implements the transfer of data flow therethrough. Specifically, in normal ATM switching, such VCs are implemented by matching the incoming cell's VPI/VCI numbers with the ingress VPI/VCI numbers of the respective VCs when using the table, and for this reason a channel change requires the internal virtual circuits to be torn down and set up (but since this is done internally, it is handled faster than tearing down and setting up VCs across a cloud of switches).

For example, during cell processing, cells in data flow 31 have the VPI/VCI numbers 30:300 and are supplied to VC 12A that has ingress VPI/VCI numbers of 30:300. Assuming each of flows 31-35 is received on a trunk VC, then the egress VPI/VCI numbers of a trunk VC match the ingress VPI/VCI numbers of a subscriber VC, whenever cells flow there between: e.g. because the egress VPI/VCI numbers of the trunk VC are used as an index into a table, to look up the subscriber VC. The remote VPI/VCI and remote port number that are used to transmit a cell on the subscriber VC, are held in the table, as attributes of the subscriber VC.

When a subscriber using set-top I requests a change in the data flow (e.g. selects a new data flow 33), then VC 12I is torn down, as illustrated in FIG. 4B. Thereafter, new VC 12Z is formed, as illustrated in FIG. 4C. Note that the existing VC 12I cannot be used to carry data flow 33, because of the reason noted above. Specifically, in normal ATM switching, the table is created using the ingress VPI/VCI numbers and the egress VPI/VCI numbers of the subscriber VCs. Thereafter, the VPI/VCI numbers of the incoming cells are used to lookup this table, and therefore the cell VPI/VCI numbers must match the ingress VPI/VCI numbers of the subscriber VC that is to carry the cells.

In the example illustrated in FIG. 4A the cells that form data flow 33 contain VPI/VCI numbers 15:101, whereas VC 12I has the ingress VPI/VCI numbers 15:100. Since there is no match for these cells in the table, these cells are dropped. To make a cell's VPI/VCI numbers match to the ingress VPI/VCI numbers of a subscriber VC (e.g. when a newly-selected data flow is to be provided to the subscriber), it is necessary in normal ATM switching to change the just-described table.

Such a change is performed in this example by first tearing down VC 12I (FIG. 4B) thereby to delete an existing row in the table (having the ingress VPI/VCI number of VC 12I as the key), and creating a new VC 12Z (FIG. 4C) thereby to add a new row in the table (having the ingress VPI/VCI number of VC 12Z as the key). Note that if multiple subscribers are desirous of receiving the same data flow, then a point to multipoint PVC may be used in the example illustrated in FIGS. 4A-4C. In such a case, when a subscriber requests a change in the data flow, a leaf in this point to multipoint PVC is removed, and another leaf may be added in another point to multipoint PVC.

During the tear down and set up of a leaf of a point to multipoint virtual circuit (such as a PVC or a SVC) as illustrated in FIGS. 4A-4C, a number of additional functions are normally performed (e.g. bandwidth that was previously allocated for VC 12I is now released, and the same amount of bandwidth for VC 12Z is now allocated, and various other internal signals are generated). In one embodiment, the following steps are performed to set up a VC (or a leaf of a point to multipoint VC) in conformance with the ATM protocol:

1. Allocate a flow ID for the VC

2. Check for available bandwidth

a. On the ingress port

b. On the egress port

c. On the backplane bus from the ingress line unit to the central switching unit

d. From the central switching unit to the egress line unit

3. Allocate BW on the above four locations:

a. On the ingress port

b. On the egress port

c. On the backplane bus from the ingress line unit to the central switching unit

d. From the central switching unit to the egress line unit

4. Allocate the necessary time slots on the backplane bus (which is time division multiplexed among the various line units)

5. Signal to the active central switching unit

6. Signal to the backup central switching unit

7. Signal to the ingress line unit

8. Signal to the egress line unit

9. Update the tables at the bus-interfaces of the various units:

a. bus interface on the ingress line unit

b. bus interface on active central switching unit

c. bus interface on backup central switching unit

d. bus interface on the egress line unit

10. Update mapping (e.g. see Table A described below) in the network processor of the ingress line unit

11. Write configuration state to flash memory on active central switching unit

12. Write configuration state to flash memory on backup central switching unit

In certain embodiments, performance of such functions for each channel change requires hundreds of operations by driver software executing in the central processing unit (CPU). Elimination of performance of such functions by embodiments of the type illustrated in FIGS. 3A and 3B during channel change results in one or more orders of magnitude faster operation than embodiments of the type illustrated in FIGS. 4A-4C. For this reason, elimination of the tear down and set up of a virtual circuit during channel change is a critical aspect of the embodiments illustrated in FIGS. 3A and 3B.

Specifically, one implementation of the embodiments illustrated in FIGS. 3A and 3B sets up two types of VCs: one type of VC (also called “transport VC”) from a real port (e.g. OC-12 port) on a line unit that receives the data flow from an upstream device, to a pseudo port PP2 in that line unit, and another type of VC (also called “subscriber VC”) from a pseudo port PP1 in that line unit to the real port (e.g. ADSL port) on another line unit that services set-top boxes. In setting up these VCs, a number of steps of the type described above are performed. Specifically, all of steps 1-12 are performed in setting up a subscriber VC, and many of these steps are performed in setting up a transport VC (except that the following steps are not performed: 2b, 2c, 2d, 3b, 3c, 3d, 9a, 9b, 9c and 9d).

Once the just-described VCs are set up, they are kept intact during channel change by simply using VC-VC associations (e.g. VC-VC associations 121 and 122 in FIGS. 3A and 3C), which are maintained in an internal mapping (such as Table A described below). Specifically, a VC-VC association is created when data is to be transferred from a transport VC to a subscriber VC (e.g. a handle is created and stored in a mapping in the ingress line unit, and the handle is informed to an IP unit for use in channel change). The IP unit simply updates the table of VC-VC associations (such as Table A described below) without affecting the above-described VCs.

In certain embodiments, a data flow that is to be transferred between two or more line units in access multiplexer 100 is encapsulated in one or more fixed length data units (also called “fixed length packet” abbreviated as “flp”) by trunk line unit 140 (FIG. 3A) and sent to a central switching unit (not shown) for appropriate routing to one or more subscriber line units. A flp has a format that is similar or identical to the format of an ATM cell, except that certain additional fields are present as discussed herein.

Specifically, each flp includes a routing map in a header, to identify the specific line unit(s) to which the flp is to be transferred by the central switching unit. The routing map is built by the trunk line unit 140 (FIG. 3A), based on the above-described mapping, so that a copy of the flp is transmitted by the central switching unit to the appropriate subscriber line units (that have a VC to a subscriber desirous of receiving that specific data flow). Therefore, on receipt of each flp from a trunk line unit, the central switching unit looks up the routing map included therein and transfers one or more copies of the flp to the subscriber line units identified in the routing map.

In several embodiments, the header of a flp also contains a number (called “flow identifier”) that is inserted therein by a trunk line unit. Such a flow identifier is globally unique within the entire access multiplexer 100, and is generated during provisioning of trunk VC. Note that in one particular embodiment, the low-order 5 bits are used to identify the port to which the flow is being supplied.

In one example, a cell containing VPI/VCI of 15/100 is received on trunk VC 101A (FIG. 3A), and this cell carries data for the video channel HBO. Trunk line unit 140 (FIG. 3A) uses this cell's VPI/VCI number of 15/100 to lookup a table (in the local memory of unit 140), which in turn provides a flow identifier of value 23 (that was previously stored therein). Trunk line unit 140 thereafter inserts this value 23 in the header of the flp, before transmission to the central switching unit.

In one specific embodiment, on receipt of the flp in each subscriber line unit, a network processor contained therein uses the flow identifier value 23 to look up its own tables, to determine one or more ports (that are local to that particular subscriber line unit) on which a copy of a data unit (which is embedded in the flp) is to be transmitted (e.g. port 3), and also to determine the egress VPI/VCI number (e.g. the value 1:35) to be used when transmitting the data unit to the subscriber.

In one particular embodiment, there is no network processor in any of the subscriber line units, and for this reason the subscriber line units are unaffected when performing a channel change. An exemplary Table A before the channel change (as per FIG. 3A) is illustrated below:

TABLE A

| Cell's | | | Subscriber | | Subscriber | |
|---|---|---|---|---|---|---|
| VPI/VCI | | Subscriber | VC | Subscriber's | VC Egress | Set-top |
| (key) | Content | Flow Id | handle | Shelf/Slot/Port | VPI/VCI | label |
| 15/100 | HBO | 33 | 1 | 1/1/1 | 1:35 | 130I |
| 15/101 | ESPN | — | — | NULL | — | — |
| 15/102 | NBC | — | — | NULL | — | — |

The above table uses certain exemplary values for the flow identifier (“flow ID”). In this example, the low order five bits of the flow ID must map to the port number on the subscriber line unit. So port number 1 on any subscriber line unit in any shelf maps to possible flow IDs 1, 33, 65, 97 . . . Flow IDs must also be globally unique in the access multiplexer of this example. Also in this example, indexing starts at 1 (and hence there is no node zero or shelf zero). For this reason, the first port on a subscriber line unit in the first slot of the first shelf is labeled 1/1/1.

Although the above-described table is illustrated as identifying only one subscriber VC, any number of subscriber VCs may be identified by each entry in such a table. When multiple subscriber VCs are identified for a flow, trunk line unit 140 generates all copies of a cell that are identified as being needed to be provided to any one subscriber line unit. In one example, there are 24 ports on a single subscriber line unit 150 and a subscriber on each port desires the same video channel, and for this reason a cell of that video channel is replicated 24 times by the transport line unit 140, and the resulting 24 flps are then transmitted to the subscriber line unit 150 (in a method referred to as “source casting”).

In addition, access multiplexer 100 of one particular embodiment also uses another method (also referred to as “spatial casting”) as follows. If the same data flow needs to be provided to two (or more) subscribers that are serviced by ports on different subscriber line units, which ports have the same port number (because it is local to each subscriber line unit), then the trunk line unit transmits only one copy of the flp, but the trunk line unit identifies the two (or more) subscriber line units that are to receive the flp, in the route map that is transmitted in the flp header.

In the example illustrated in the above table and in FIG. 3A, cells of VPI/VCI numbers 15/101 and 15/102 are not forwarded by trunk line unit 140 (i.e. they get dropped) because their respective entries in an internal table of line unit 140 are empty (e.g. if the table yields a NULL value as the identifier of the subscriber line unit to which these cells are to be forwarded). However, use of VPI/VCI number 15/100 as an index into the table yields a non-NULL value, e.g. the value 1/1/1, which indicates that the cell is to be forwarded to the 1^{st} port on the 1^{st} subscriber line unit 150 (note that these values are merely exemplary) in the 1^{st} shelf to which set-top 130I is connected by the local loop as shown in FIG. 3A.

Note that the just-described value 1/1/1 was previously stored in the above table into a row that was found by using the egress VPI/VCI number 15:100 of the HBO channel as an index. The just-described storage was done when a subscriber serviced by this particular subscriber line unit 150 had requested this specific data flow HBO (of which the cell being currently processed is a part). Specifically, if STB 130I is on port 1 of subscriber line unit 150, this value 1/1/1 is stored in the above table, as being associated with a flow identifier 33 which uniquely identifies HBO.

Therefore, on receipt of a flp containing flow identifier 33, subscriber line unit 150 strips the header to generate a cell to be transmitted on port 1. In addition, this table also contains the egress VPI/VCI number of subscriber VC 102I (FIG. 3A) which is to carry this data flow, and in this example the value is 1:35. Hence, prior to transmission of the flp, the transport line unit 140 inserts the value 1:35 into a header of the flp, which is then transmitted to the subscriber line unit.

Since the same flp is transmitted to each subscriber line unit, for transmission to subscribers who are being serviced by ports with identical port numbers, the egress VPI/VCI numbers must be identical in the just-described embodiment. In alternative embodiments, if any egress VPI/VCI number is to be supported, such a unique VPI/VCI number for each subscriber may be held in and inserted by the subscriber line unit. Alternatively, a fixed VPI/VCI number is used in some embodiments, to support existing modems which expect the cells carrying the video data flow to have that VPI/VCI number regardless of channel change. Depending on the implementation, the fixed VPI/VCI number may be inserted either by the subscriber line unit or by the trunk line unit.

A channel change to effect delivery of a newly-selected data flow (illustrated in FIG. 3B) to subscriber VC 102I can affect one or more entries in either or both of the above-described tables (also called multicast tables). The tables that are affected is regardless of whether both tables are stored in the transport line unit, or one table is stored in the transport line unit and other table is stored in subscriber line unit).

The entries being affected depend on whether or not other subscribers are receiving the old data flow and/or the newly-selected data flow. In the example illustrated in FIGS. 3A and 3B, only one subscriber is involved and for this reason two entries in the above table in trunk line unit 140 are changed: the port identifier 1/1/1 is replaced with the value NULL as being associated with egress VPI/VCI number 15:100 of trunk VC 101A and the port identifier NULL previously associated with egress VPI/VCI number 15:102 of trunk VC 101P is replaced with the value 0/0/1. The changed table (which is now labeled Table B) is as follows:

TABLE B

| | | | Subscriber | | Subscriber | |
|---|---|---|---|---|---|---|
| Cell's | | Subscriber | VC | Subscriber's | VC Egress | Set-top |
| VPI/VCI | Content | Flow Id | handle | Shelf/Slot/Port | VPI/VCI | label |
| 15/100 | HBO | — | | NULL | — | |
| 15/101 | ESPN | — | | NULL | — | |
| 15/102 | NBC | 33 | 1 | 1/1/1 | 1:35 | 130I |

In effecting the channel change, note that the PVC tables in the access multiplexer are not touched (i.e. only multicast tables of the type shown above that are used in the switching function are impacted).

When trunk line unit 140 implements these changes, cells being received on trunk VC 101A are dropped, and cells being received on trunk VC 101I are forwarded to subscriber line unit 150. As noted above, cells are transferred between line units 140 and 150 in the form of flps, except that after the channel change the flp payloads have different content. Note that the flp headers contain the same flow identifier e.g. value 33 (thereby to indicate that data is being transferred to the same port). Note that these flps may also have the same routing map as the previously transferred flps (indicative of transfer to the same subscriber line unit, i.e. shelf/slot number 1/1).

In implementing the channel change illustrated in FIGS. 3A and 3B, the only actions that are performed is updating one or more tables in each of the two line units. Therefore, it is not necessary when implementing the channel change in FIGS. 3A and 3B to perform any other actions that are normally performed, e.g. to tear down a VC or to set up a VC of the type described above in reference to FIGS. 4A-4C. Elimination of such actions speeds up channel change, because several embodiments implement the channel change of FIGS. 3A and 3B in fewer steps, and steps that require minimal time (e.g. updating tables is quicker than sending signals and waiting for responses).

After channel change, flps of flow identifier 33 are still received by the subscriber line unit 150 but contain different data as noted above. The above-described replacement of value 1/1/1 with NULL in the table of trunk line unit 140 is not done if another subscriber being serviced by this line unit 150 is receiving the data flow in trunk VC 101A. Moreover, the above-described replacement of value NULL with value 1/1/1 in this table would not be required if the value is already 1/1/1, e.g. if another subscriber serviced by this line unit 150 is receiving the data flow in trunk VC 101I.

In an alternative embodiment, subscriber line units have a network processor and maintain tables that are used for replicating cells for transmission on the individual ports. In such an embodiment, a channel change requires not only changing entries in a table (also called “trunk table”) in trunk line unit 140, but also one or more entries in another table (also called “subscriber table”) in subscriber line unit 150. Specifically, in the above-described example illustrated in FIG. 3A, an entry in the trunk table which identifies a subscriber line unit in slot 1 as receiving flow with id 33 is changed to NULL thereby to no longer receive this flow.

Moreover, another entry in the trunk table is made for the cells with VPI/VCI number 15/102, wherein flow id 33 is added thereby to provide the newly-selected flow to subscriber line unit 150. In addition, a subscriber table in line unit 150, which associates flow identifier 33 with port 1/1/1 and VPI/VCI of 1:35 is left unchanged, so that the new flow can be provided to the requesting subscriber.

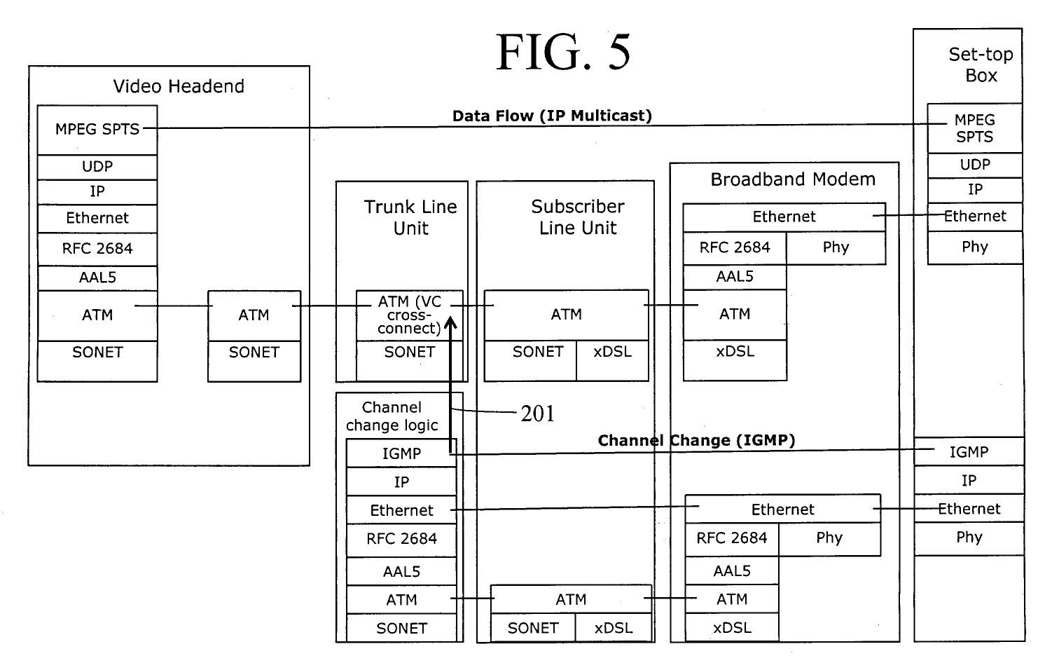

Referring to FIG. 5, in certain embodiments, the ATM cells that form each data flow are prepared in accordance with AAL5, and data for AAL5 is provided in accordance with RFC 2684 (that is published by IETF in September 1999) which in turn is provided in the form of Ethernet packets, that in turn encapsulate IP packets, which in turn encapsulate UDP datagrams, that in turn encapsulate the video frames in the MPEG SPTS format. In some embodiments, during transmission of a video feed from a video head end to a set-top box, cells carrying the video feed are not decapsulated (e.g. to obtain a protocol data unit (PDU) based on AAL5) by access multiplexer 100 when supporting constant bit rate (CBR), as illustrated in FIG. 5. However, in other embodiments (not shown in FIG. 5) that support guaranteed frame rate (GFR), PDUs are re-assembled (in conformance with AAL5, using the payload from each of a number of cells) by access multiplexer 100, and the entire PDU is rejected if even one cell is out of conformance. As illustrated in FIG. 5, a layer 3 entity in certain embodiments of the invention (e.g. a channel change logic) generates a signal 201 for changing the data flow within a layer 2 entity (e.g. a trunk line unit), while keeping intact all layer 2 connections (e.g. virtual circuits) that carry the data flow (into and out of the layer 2 entity).

Network processor 105 is implemented in some embodiments by a set of three chips called PayloadPlus™ available from Agere Systems, and that is described in a product brief published April 2001 (that incorporated by reference herein in its entirety), available on the Internet at http://www.agere.com/metro_regional_transport/docs/rsp_product_brief.pdf. One chip called “Fast Pattern Processor” and abbreviated FPP classifies the data units (e.g. cells) being received, another chip called “Routing Switch Processor” abbreviated RSP which uses the classification and analysis by the FPP to make changes and forwarding decisions, and yet another chip called “Agere System Interface” abbreviated ASI provides an interface to the CPU on the trunk line unit. Of note, the RSP allows external logic (such as a driver in the CPU) to control the transfer of cells between various queues, thereby to allow VC-VC associations between trunk VCs and subscriber VCs to be changed in the manner described herein.

In one specific implementation that uses the above described ASI, FPP and RSP, the following pseudo-code provides an outline of the acts performed when a VC-VC association is to be added or removed. Specifically, a driver in the CPU either adds or removes Agere hardware programming for the following objects below. For adding new hardware packet flows, the objects are created in order shown. For removing packet flows, the objects are deleted in the reverse order. In the following pseudocode, “Pp” stands for “Payloadplus”.

| | |
|---|---|
| > | Ingress Flows: |

| | |
|---|---|
| > | API: IngressFlow( ) |

| | |
|---|---|
| > | + Tracking objects: |

| | |
|---|---|
| > | + Connection Id |

| | |
|---|---|
| > | API: PpAllocateNewConnId( ) |

| | |
|---|---|
| > | + PduId |

| | |
|---|---|
| > | API: PpGetPduIdFromConnId( ) |

| | |
|---|---|
| > | + Destination Id |

| | |
|---|---|
| > | API: PpGetDidFromConnId( ) |

| | |
|---|---|
| > | + Flow Queue Id |

| | |
|---|---|
| > | API: PpGetQidFromConnId( ) |

| | |
|---|---|
| > | + Agere RSP Flow queue and traffic parameters: |

| | |
|---|---|
| > | API: PpSetIngressQidParameters( ) |

| | |
|---|---|
| > | + Agere RSP Destination Id Entry |

| | |
|---|---|
| > | + Packet modification rules (SED scripts) |

| | |
|---|---|
| > | API: SetIngressDidParameters( ) |

| | |
|---|---|
| > | + Agere FPP tag-reassembly table: |
| > | Key: vpi/vci |

| | |
|---|---|
| > | Return: tag and PduId |

| | |
|---|---|
| > | Egress Flows: |

| | |
|---|---|
| > | API: EgressFlow( ) |

| | |
|---|---|
| > | + Tracking objects: |

| | |
|---|---|
| > | + Connection Id |

| | |
|---|---|
| > | API: PpAllocateNewConnId( ) for creation |

| | |
|---|---|
| > | PpFreeConnId( ) for deletion |

| | |
|---|---|
| > | + PduId |

| | |
|---|---|
| > | API: PpGetPduIdFromConnId( ) |

| | |
|---|---|
| > | + Destination Id |

| | |
|---|---|
| > | API: PpGetDidFromConnId( ) |

| | |
|---|---|
| > | + Flow Queue Id |

| | |
|---|---|
| > | API: PpGetQidFromConnId( ) |

| | |
|---|---|
| > | + Agere RSP Flow queue and traffic parameters: |

| | |
|---|---|
| > | API: PpSetEgressQidParameters( ) |

| | |
|---|---|
| > | + Agere RSP Destination Id Entry |

| | |
|---|---|
| > | + Packet modification rules (SED scripts) |

| | |
|---|---|
| > | API: SetEgressDidParameters( ) |

| | |
|---|---|
| > | + Agere FPP tag-reassembly table: |
| > | Key: flowId |

| | |
|---|---|
| > | Return: Tag and PduId |

>

One illustrative example of an embodiment of access multiplexer 100 receives only one copy of each of a number of video channels and distributes them to subscribers as follows. The channel change protocol used is IGMP, version 2. For xDSL, ATM-level channel switching is performed by a trunk line unit serving the subscriber in response to instructions from the IP unit. For FTTH, Ethernet level switching is performed by the trunk line unit, also in response to instructions from the IP unit. An IP unit can be deployed on a shelf residing at a CO or RT. This IP unit can be used to process channel change requests for subscribers served by shelves residing at the CO or RT and at subtending RTs. An IP unit of this example supports the video functions for up to 10,000 settops.

In the illustrative example, to prevent unauthorized access to video services, each drop serving a video subscriber is first provisioned to support video. Further security can be provided by provisioning each drop with the MAC addresses of the authorized settops to be served on the drop. For xDSL, each drop is configured with a set of PVCs to carry the following types of broadband traffic to and from the subscriber (a) IGMP traffic—each xDSL video drop is configured with an IGMP PVC for carrying IGMP signaling between access multiplexer 100 and subtending settops; (b) Application Signaling and Internet traffic—each xDSL video drop is configured with a Signaling/Data PVC for carrying application layer signaling (e.g., to order a PPV movie) and Internet data. Depending on the capabilities of the xDSL modem, the Signaling/Data and IGMP PVCs may be same (as noted above); for a modem that is capable of IGMP snooping (or segregating traffic based on the destination IP address), the Signaling/Data and IGMP PVCs may be different; for a gateway device, IGMP and Application Signaling may be carried on one PVC and Internet access may be carried on another.

In the illustrative example, two configurations are supported for configuring broadcast traffic in the access network and one configuration is selected based on the capabilities of the CPE:

1. In the case where the modem is limited to the number of PVCs that it can support, each xDSL video drop is provisioned with one or more subscriber PVCs. These PVCs are used to deliver broadcast video channels to the subscriber. That is, when a settop on a given drop sends an IGMP Join message, the IP unit maps the specified IP multicast address to the corresponding subscriber PVC and instructs access multiplexer 100 to cross connect this subscriber PVC to one of the trunk PVCs on the subscriber's drop.

2. In the second case, when a more functional Gateway is deployed, ATM VCs are not used to send data flows to subscriber STBs. Instead, Ethernet packets are sent directly over the local loop which may be, for example, fiber in the form of FTTH (fiber to the home). In such a case, an IP unit (that contains channel change logic 111) is provisioned with a maximum number of video streams that can be supported on each drop. In this configuration, when the CPE sends an IGMP Join message for a given channel, channel change logic 111 maps the IP multicast address to the transport PVC, and instructs network processor 105 to join that subscriber drop to the multicast group.

Note that in some embodiments that are compliant with FS-VDSL (described above), the video data flow is sent to the subscriber using the same VPI/VCI value that is used to terminate the data flow at network processor 105.

In the illustrative example, access multiplexer 100 supports 1:N backup on the IP unit located on the same shelf. When a backup IP unit is installed, access multiplexer 100 automatically switches channel change requests to the backup IP unit when a failure is detected on the primary IP unit. All configuration information provisioned on the active IP unit is also automatically provisioned on the backup IP unit. Likewise, all operational information (e.g., IP Multicast Group membership information) for all active IP units is downloaded to the respective backup IP units.

In the illustrative example, access multiplexer 100 supports the provisioning of an Ethernet MAC address to each IP unit. Access multiplexer 100 also supports the provisioning of a master IP unit; all IP units on the shelf (active and backup) use the MAC address of the master IP unit. This Ethernet MAC address is used by all IP units on the shelf within all IGMP, DHCP, and ARP messages exchanged with subtending settops and PCs and with a headend router.

Moreover, each IP unit of the illustrative example supports a communication link with the subtending access multiplexer shelves (also called “chassis”) that it services. Specifically, each IP unit supports a unique set of subtending shelves (e.g. up to 20 access multiplexer shelves). When a backup IP unit is activated, it establishes a communication link with the access multiplexer shelves that were managed by the IP unit being replaced. Furthermore, each IP unit is able to support a maximum of 10,000 settop devices concurrently, and is able to process up to 2000 concurrent channel change requests per second. In this example, there are two messages per channel change: a leave followed by a report (join).

Furthermore, in the illustrative example, each IP unit performs a channel change in an interval of under 1 second. Channel change is defined as the time interval from when the IGMP Leave message is received by the IP unit (to discontinue the transmission of a channel to a settop), until the time that the first IP packet containing the new video stream is routed on the subscriber's drop. (This assumes that the settop follows the Leave message with a Join message for the new channel within 100 milliseconds of sending the Leave message.)

In the illustrative example, the IP unit maintains a list of all subscribers that are watching a video data flow being broadcast to each IP multicast group (by the video headend). The level at which this tracking is done depends on the behavior of the middleware deployed in the settops. Specifically, a configuration parameter that is manually specified to the access multiplexer characterizes the settop middleware behavior. This parameter is set to “yes” when the settop middleware deployed on the subtending settops responses to all Query messages and always sends a Leave message when leaving a multicast group. Alternately, this parameter is set to “no” when the settop middleware deployed does not reply to all Query messages and/or always send a Leave message when leaving a multicast group.

When the settop configuration parameter is set to “no,” the IP unit tracks membership in each group on an interface basis as defined by RFC 2236. That is, the IP unit tracks membership on a combined basis for the access multiplexer's shelf and drop. When the settop configuration parameter is set to “yes,” the IP unit tracks membership in each group on a settop basis, i.e., on a combined basis for access multiplexer, shelf, subscriber port, and either Ethernet MAC address or IP address.

In the illustrative example, the IP unit updates each group membership list when any of the following events occurs:

The IP unit adds a settop to the group membership list in response to an IGMP Join message. The IP unit does not modify the membership list if it determines that the settop is already a member of the group when the Join message was received.

The IP unit deletes a settop from the group membership list in response to an IGMP Leave message. The IP unit does not modify the membership list if it determines that the settop was not a member of the group when the Leave message was received.

The IP unit verifies and updates its membership lists upon receiving a Report message received in response to an IGMP General Query or Group-Specific Query message.

The IP unit deletes a settop from a membership list if it does not receive a Report message following an IGMP General Query or Group-Specific Query.

The IP unit deletes a settop from a membership list after an IP address assignment expires for that settop following an ARP timer expiry (i.e., an Ethernet MAC fails to respond to an ARP request).

In the illustrative example, the access multiplexer supports ATM level multicasting. For each ATM multicast group, the access multiplexer maintains a table of the outgoing trunks and/or subscriber drops that are members of the group. The access multiplexer allows a subscriber drop or a trunk to be added or removed from an ATM multicast through provisioning. The access multiplexer is able to dynamically add and remove a subscriber drop from an ATM multicast in response to an intershelf control message from the IP unit.

In the illustrative example, the access multiplexer allows the following entities to be a member of an ATM multicast:

A subscriber served by an xDSL drop. The subscriber is identified by the subscriber side port id on the xDSL drop. The video stream is delivered either on a Broadcast PVC pre-provisioned on the drop or on the same VPI/VCI on which the stream terminates at the Serving access multiplexer shelf. The method used is configurable through provisioning.

A subscriber served by a GE or FE drop. The subscriber is identified by the port id. When multicasting to a Gigabit Ethernet drop, the access multiplexer first removes the AAL5/ATM layer of the incoming stream, and transmits the recovered Ethernet frames on the VLAN provisioned for broadcast video (e.g. in embodiments that use VLAN instead of ATM VCs).

An outgoing SONET or DS3 trunk. The trunk is identified by the port id. The video stream is delivered either on a Broadcast PVC pre-provisioned on the trunk or on the same VPI/VCI on which the stream terminates at the Serving access multiplexer shelf. The method used is configured during provisioning.

In the illustrative example, the access multiplexer performing ATM multicasting is also able to transport the multicast PVCs on to a subtending node, independent of any ATM multicast switching. The IP unit sends intershelf control messages to an access multiplexer shelf residing at the same node or at a subtending node, instructing the access multiplexer shelf to add or remove a member from an ATM multicast. The member is identified as:

For xDSL, a subscriber side port id and the ATM VCC on which the stream is delivered (either a preprovisioned Broadcast PVC or the same VPI/VCI on which the stream terminates at the Serving access multiplexer shelf.

For a GE or FE drop, a port id and the VLAN tag provisioned on the drop for broadcast video.

For a given SONET or DS3 card, the port id and the ATM VCC to be used for delivering the video stream (either a preprovisioned Broadcast PVC or the same VPI/VCI on which the stream terminates at the Serving access multiplexer shelf).

In the illustrative example, the access multiplexer supports ATM multicasting from 1 to 3 nodes within a given path in the access network. That is, the access multiplexer allows broadcast channels to terminate at one node (CO or RT) and be multicast out to one or more subtending nodes. Within a given path from the CO to the RT serving the subscriber drop, the access multiplexer allows multicasting to occur at 1 to 3 nodes. To achieve this, the following applies:

Upon receiving an IGMP Join message, the IP unit is able to identify the path through the access network needed to deliver a channel to a given subscriber. This path is defined through provisioning.

The IP unit supports intershelf control signaling to instruct up to 3 nodes in a given path to add and remove a member from a given ATM multicast.

The access multiplexer allows an intermediate trunk to be dynamically added and dropped from an ATM multicast in response to an intershelf control message from the IP unit. In this case, the outgoing trunk is identified by the port and ATM VCC to be used for delivering the video stream (i.e., the same VPI/VCI on which the stream terminates at the Serving access multiplexer shelf).

Upon receiving an IGMP Join message from a subtending settop, the IP unit of the illustrative example determines if this is the first member on the drop to join the Multicast Group.

If it is, the IP unit adds the settop to the Multicast Group membership list (described above) and instructs the serving access multiplexer shelf to add the subscriber to the corresponding ATM multicast.

If the IP unit is performing membership tracking on a settop basis and determines that there is another settop on the drop that is already a member of the Multicast Group, the IP unit adds the settop that sent the Join message to the Multicast Group membership list.

If the IP unit is performing membership tracking on a settop basis and determines that the settop that sent the Join message is already a member of the Multicast Group, the IP unit leaves the membership list as is.

If the IP unit is performing membership tracking on a drop basis and determines that the drop from which the Join message was received is already a member of the Multicast Group, the IP unit leaves the membership list as is.

In the illustrative example, upon receiving an IGMP Join message from a subtending settop, the access multiplexer responds as discussed above. If the IP unit determines that the subscriber drop is not already receiving the multicast, it sends an intershelf control message to each access multiplexer shelf as needed to establish the connection from a virtual port (where the broadcast channel from the video headend terminates) to the serving access multiplexer shelf.

In the illustrative example, when the IP unit is performing membership tracking on a settop basis, if an IGMP Leave message is received from a subtending settop, the access multiplexer checks the Multicast Group membership list to determine if it is the last member on the drop to leave the given Multicast Group.

If it is, the IP unit performs a fast release of the settop from the Multicast Group.

If the membership list indicates that there is at least one other member on the port that is in the given Multicast Group, the access multiplexer performs a slow release of the settop from the group.

If the access multiplexer determines that the settop that sent the Leave message is not a member of the Multicast Group, the access multiplexer ignores the Leave message.

In this example, when the IP unit is performing membership tracking on a drop basis, if the IP unit receives an IGMP Leave message from a subtending settop, the IP unit does one of the following:

If the membership list indicates that the drop from which the Leave message was received is a member of the given Multicast Group, the IP unit performs a slow release of the settop from the group.

If the IP unit determines that the drop from which the Leave message was received is not a member of the Multicast Group, the access multiplexer ignores the Leave message.

To provide a fast release of a settop from a Multicast Group following an IGMP Leave message, the access multiplexer in this example performs the following:

The IP unit instructs the serving access multiplexer shelf to remove the subscriber drop from the ATM multicast.

The IP unit removes the settop that sent the Leave message from the Multicast Group membership list.

The IP unit sends an IGMP Group-Specific Query message to the subscriber drop, set the Last Member Query timer, and await a response. If no messages are received within the Last Member Query timer interval, the IP unit retransmits the message and reset the timer n times, where n is set to a value of [Last Member Query Count], as defined in provisioning.

If a Report message is received in response to the Query, the IP unit in this example cancels the Last Member Query timer, adds the settop (that sent the Report) to the Multicast Group membership list, and instructs the network processor to add the settop to the ATM multicast. Alternately, if no Report messages are received by the last expiry of the Last Member Query timer, the access multiplexer considers the Leave transaction to be complete.

To provide a slow release of a settop from a Multicast Group following an IGMP Leave message, the IP unit in this example first sends an IGMP Group-Specific Query message to the subscriber drop, sets the Last Member Query timer, and awaits a response. If no messages are received within the Last Member Query timer interval, the IP unit retransmits the message and reset the timer n times, where n is set to a value of [Last Member Query Count], as defined in provisioning.

If the IP unit in this example receives a Report message in response to the Query, the IP unit cancels the Last Member Query timer, verify that the settop that sent the Report is on the membership list for that group (when membership tracking is done on a settop basis), and retains the connection between the Multicast PVC and the subscriber's port. When membership tracking is done on a settop basis, if the settop that responded is not already a member of the group, the IP unit adds the settop to the Multicast Group membership list. If no Report messages are received by the last expiry of the Last Member Query timer, the IP unit removes all members on the port from the Multicast Group membership list and instructs the serving access multiplexer shelf to remove the subscriber drop from the ATM multicast.

Upon receiving a Leave request, the IP unit in this example proceeds as discussed above. In addition, if no Report messages are received by the last expiry of the Last Member Query timer, the IP unit determines if the serving access multiplexer shelf is delivering the given channel to any other drop. If not, the IP unit instructs the access multiplexer that is upstream from the serving access multiplexer shelf to remove the serving access multiplexer from the ATM multicast. The IP unit in this example is able to perform this process on 1-3 access multiplexer shelves in a given path (including the serving access multiplexer).

If the IP unit in this example receives an IGMP message from a subscriber drop from a settop that is not provisioned, the IP unit does one of the following, as defined by provisioning:

If MAC provisioning is required, the IP unit drops the message.

If MAC provisioning is not required, the IP unit accepts and processes IGMP messages from the subscriber as long as the drop has been provisioned for video and the IP address is an assigned and valid address for that interface. The IP unit ignores an IGMP message received on an interface that is not provisioned for video or if the IP address is unassigned or invalid for the interface. The subscriber line units in this example support the following capabilities:

Support multiple classes of service: CBR, UBR, VBR-rt, VBR-nrt, and GFR (with packet discard)

Minimum of 16 active VPI/VCI values per interface

Support the full VPI/VCI UNI address field

Support address translation through the system.

The access multiplexer in this example supports the ability to overprovision a drop with video related PVCs. The access multiplexer allows the video application on the IP unit to manage the bandwidth by limiting the number of concurrent streams that are sent on a given interface.

The access multiplexer in this example supports 802.1 p priority bits on a GE and FE interface. The access multiplexer is able to limit the upstream and downstream bandwidth for each VLAN on a given drop.

Moreover, the access multiplexer in this example supports the provisioning of a limit to the number of concurrent video streams that can be delivered on a given interface and to a single settop device. If the access multiplexer receives an IGMP Join message from a settop and has determined from the Multicast Group tables that the per settop and per interface limit has not been reached, the IP unit processes the Join message as defined above. If the access multiplexer determines that either the interface or the settop limit has been reached, the IP unit drops the message. The IP unit maintains an error count of the number of times this error occurs on a drop and access multiplexer shelf basis. The IP unit allows the service provider to access and initialize this error count through the iMS/CMS graphical user interface.

If the access multiplexer in this example receives an IGMP Join message from a settop served by an xDSL drop and determines there is not enough provisioned or available xDSL bandwidth on the drop to deliver the channel, the IP unit drops the message. The IP unit in this example maintains an error count of the number of times this error occurs on a drop and access multiplexer shelf basis. The IP unit allows the service provider (also called “LEC”) to access and initialize this error count through a graphical user interface.

For mapping IP addresses to MAC addresses, the access multiplexer in this example supports the Address Resolution Protocol (ARP) per RFC 826, An Ethernet Address Resolution Protocol or Converting Network Protocol Addresses to 48.bit Ethernet Address for Transmission on Ethernet Hardware, published by the IETF, and this document is incorporated by reference herein in its entirety.

Moreover, in the downstream direction, the access multiplexer of this example supports RFC 2684 to remove the ATM encapsulation and recover the Ethernet frames for video and data traffic to be sent to a GE or FE drop. In the upstream direction, the access multiplexer performs RFC 2684 encapsulation of all IP packets received from a GE or FE drop that are not directed to the IP unit's IP address before forwarding the packets to the network side Data PVC or to an xDSL drop.

The access multiplexer in this example supports the provisioning of the parameters defined in this section via a dumb terminal and via the graphical user interface. Specifically, the access multiplexer graphical user interface uses TL1 and SNMP for provisioning these parameters. FS-000052, VDSL System Architecture, defines a preliminary set of video MIBs for switched video services. The access multiplexer in this example is compliant with these FS-VDSL specified MIBs.

The access multiplexer in this example also supports video service provisioning to an xDSL port, GE port, and FE port. Also, the access multiplexer in this example supports the ability to provision IP addresses to settops and user PCs, using a DHCP gateway agent. The access multiplexer implements a DHCP server on the subscriber side for the assignment and allocation of these IP addresses. These addresses can either be configured on the access multiplexer in this example or dynamically obtained by DHCP. To this end, the access multiplexer implements a DHCP client on the network side. This client is used to acquire individual IP addresses or IP address blocks using the IP subnet block option from DHCP servers residing in the service provider or Internet Service Provider domain.

The access multiplexer in this example also supports, as a service provider option, the ability to provision one or more settop MAC addresses to an xDSL, GE or FE port. If settop provisioning is used by the service provider, the IP unit requires the settop MAC address to be provisioned to the xDSL, GE or FE drop before accepting and processing any IGMP and other IP packets from the settop.

If settop provisioning is not used by the service provider, the IP unit accepts and processes IGMP messages and other IP packets from any MAC address on a provisioned video port as long as the IP address of the incoming packet is an assigned and valid IP address for that interface.

As noted above, to achieve accurate tracking of settop membership in each IP Multicast Group (needed to improve channel change performance), settops of this example send Membership Reports in response to all Membership Queries, even when another settop on the drop has sent a Report for the same IP Multicast Group. Likewise, the settops always send a Leave message when leaving a multicast group. As noted above, the access multiplexer in this example supports the provisioning of a parameter that defines whether the settop middleware deployed supports the modified IGMP behavior or not.

The access multiplexer in this example supports the provisioning of 1-300 Multicast Groups. For each Multicast Group, the access multiplexer in this example supports the provisioning of a network side Multicast PVC and an IP multicast address. For each IP Multicast Group, the access multiplexer in this example supports the provisioning of a network side Multicast PVC and an IP multicast address.

To support the case when the xDSL or fiber CPE can route IGMP messages on a different PVC or VLAN from application signaling and Internet data, the access multiplexer in this example supports the provisioning of 1-480 bi-directional IGMP PVCs or 1-480 upstream IGMP PVCs and 1-480 downstream IGMP PVCs between the IP unit and each serving access multiplexer shelf. The access multiplexer in this example allows a network IGMP PVC to be cross connected at the serving access multiplexer shelf to a subscriber drop and VLAN for a Gigabit Ethernet drop, or for an xDSL subscriber, to the IGMP PVC provisioned on the subscriber's drop.

The access multiplexer in this example also supports the provisioning of a network side PVC for sending and receiving ARP messages to and from the headend router. The access multiplexer in this example allows the ARP PVC to be the same as the network side Data PVC.

The access multiplexer in this example also supports the provisioning of a Signaling/Data PVC on an xDSL drop. This PVC is used for all data traffic including ARP and DHCP messages and all application server signaling. The default value for this PVC is 0,100. The access multiplexer in this example further supports the provisioning of a Signaling/Data VLAN on a GE or FE drop. This VLAN is used for all data traffic including ARP and DHCP messages and all application server signaling. The access multiplexer supports the ability to provision a minimum and maximum throughput for each VLAN on a given interface. These parameters are provisionable in ½ Mbps increments. The access multiplexer in this example also supports provisioning of a class of service for traffic to be carried on this VLAN.

The access multiplexer in this example supports the provisioning of an IGMP PVC on an xDSL drop. The access multiplexer allows the Signaling/Data PVC and IGMP PVC to be assigned the same value or different values. The default value for this PVC is 0,100.

The access multiplexer in this example supports the provisioning of an IGMP VLAN on a GE or FE drop. The access multiplexer allows the Signaling/Data VLAN and IGMP VLAN to be assigned the same value or different values. The access multiplexer can further provision a class of service for traffic to be carried on the IGMP VLAN.

The access multiplexer in this example supports the provisioning of 1-10 Broadcast PVCs on an xDSL drop. The default value for ADSL is two PVCs with VPI,VCI values of 0,101 and 0,102. The default value for VDSL is three PVCs with VPI,VCI values of 0,101; 0,102 and 0,103. This limit applies to all video traffic carried on a multicast PVC (whether it is broadcast or on-demand).

The access multiplexer in this example further supports the ability to forward multicast video streams to an xDSL subscriber using the same VPI/VCI value that is used to terminate the stream at the serving access multiplexer shelf. The access multiplexer allows the service provider to provision whether switched PVCs are used or whether pre-provisioned PVCs are to be used. This parameter applies to the entire pool of CPE managed by the IP unit. This parameter applies to all video traffic carried on a multicast PVC (whether it is broadcast or on-demand).

The access multiplexer in this example further supports IGMP timers and counters as defined in RFC 2236. The definition and use of these timers and counters are unchanged from RFC 2236. The default value for these timers and counters are as follows in this example:

IGMP Query Interval default value is 125 seconds.

IGMP Query Response Interval default value is 100 milliseconds.

IGMP Last Member Query Interval default value is 100 milliseconds.

IGMP Last Member Query Count default value is 1.

To support IP forwarding used for Internet and application server signaling, the access multiplexer in this example supports a configurable ARP timer. The timer is configurable from 1-60 minutes, in 1 second increments. The default value for this timer is 4 minutes.

Moreover, the IP unit of this example allows the provisioning of a limit to the maximum number of concurrent multicast streams that can be delivered to a subscriber port and to a single device on the subscriber port. A device is defined as a MAC address (when MAC address provisioning is supported) or as an assigned IP address. The default number of streams for ADSL is 2, the default number of streams for VDSL is 3, and the default number of streams for GE and FE is 3. The default number of streams per device in all cases is 1.

In this example, the IP unit also supports the provisioning of a MAC address to itself, for use within the IGMP, DHCP, and ARP messages exchanged with subtending devices and with a headend router. The same value is used by the primary IP unit and backup IP unit. The IP unit further supports the provisioning of a static IP address. This IP address is used by the primary and backup IP units within the IGMP, DHCP, and ARP messages exchanged with subtending devices and with a headend router.

A fully loaded IP unit in this example is capable of supporting up to 10,000 settop devices, and support a peak channel change rate of 2000 channel changes per second. Assuming 2.5 IGMP messages per channel change (Leave, Join, Report), the IP unit shelf is capable of processing 5000 IGMP messages per second.

Also, in this example, the IP unit collects periodic information on the broadcast video traffic (i.e., number of channels being viewed, number of subscribers viewing each channel) and VOD traffic (number of concurrent VOD sessions). This information is used by a service provider in engineering their network, and in quantifying traffic patterns for different types of services which are used in defining future capabilities of the access multiplexer, e.g., is how many levels are really needed for multi-level multicasting and how many subscribers can be connected to an APON or EPON before the bandwidth limit is reached. The IP unit supports the ability to turn this tracing on and off, and provides an ability to view these statistics via its GUI interface and the ability to dump this information to a separate file.

In this example, commands to access multiplexer 100 can be manually issued either through a graphical user interface or via a command line interface. The command line interface may be supported through, for example a dumb terminal connected to a serial port at which commands are entered as ASCII characters. In this example, the presence of an IP unit is initially identified to the access multiplexer by a command which states that the IP unit is located in node 10, shelf 1, slot 18. The command also states that the IP unit being identified is a “working” unit, as opposed to a backup unit (which may also be present).

Every time a VC-VC association is created in access multiplexer 100, a short-hand notation is used to refer to a traffic profile indicating information that is to be used in creating the VC-VC association (also referred to as “cross-connect”). The type of cross-connects that are created in access multiplexer 100 to support video data flows as described herein are between ATM VCs, although access multiplexer 100 of this example can provide cross-connects for other traffic: e.g. one could connect an STS on a SONET input port to an output port, and in this manner switch the entire STS. When setting up a cross-connect, the traffic profile identifies a class of service for the VCs being connected. In the following exemplary commands,“cos” is class of service and “cbr” is constant bit rate. Note that although the following commands refer to “cbr”, for video one would use “gfr” which means guaranteed frame rate.

In this example, there are 2 encoders, and video data comes in to the encoders from a DVD player that is playing a movie. The encoder needs to know the bit rate, and it's called the MPEG bit rate, and the higher the rate the more the resolution but the bandwidth needs to be higher too. In the following commands, “cdvt” is cell delay variation tolerance (in microseconds), and “pcr” is peak cell rate, and in this case it's same as constant bit rate. An ATM cell has 53 bytes, which is 424 bits×8650, which turns out to be about 3.667 Mbits (for each video data flow that uses ATM), although supporting only 2.6 Mbps MPEG rate due to overhead in headers: UDP, IP, Ethernet, etc. The following three lines describe three traffic profiles that may be used to create three types of virtual circuits, namely: (a) transport VC, (b) subscriber VC, and (c) internet protocol (IP) VC.

# Video VC profile for video transport VC

ent-prof-trf::31::::cos=cbr,cdvt=5000,pcr01=8650,app=VIDCHNL,police=n;

# Video VC profile for video subscriber VC

ent-prof-trf::32::::cos=cbr,cdvt=5000,pcr01=8530,app=VIDSUBCHNL,police=n;

# IP VC profile

ent-prof-trf::33::::cos=cbr,cdvt=20000,pcr01=618,app=IP,police=n;

In the first line above:

“ent-prof-trf” states that we are entering a new traffic profile. And 31 is just an identifier of the profile;

“cos”, “cdvt” and “pcr” were discussed above;

“app=VIDCHNL” says that VCs of this traffic profile (i.e. “transport” profile) will be used for delivering a video channel (on the trunk side) to the trunk line unit; and

“police=n” says the network processor is not to do any policing of this flow.

The policing is turned off because it was found that some of the devices group the cells too closely together, and some of the cells may be out of profile which would otherwise cause the network processor to interrupt the video data flow. Note that when VCs are set up using such a profile, the IP unit creates a record for the VC, and does binding to associate the related node, shelf, slot and port with the VC.

The second line above is similar to the first line, except that VCs set up with this profile are for supplying video data flows to subscribers by referring to a different application program “app=VIDSUBCHNL.” This application sets up the subscriber VCs to go from the trunk line unit, through the central switching unit, to the subscriber line unit and out an ADSL port to the local loop.

The third line is similar to the first and second lines, but VCs set up with this profile are used to carry IP traffic. Although in the above command “cbr” is used, one may alternatively use “ubr”. These VCs are set up to carry control information.

In this example, the following commands are used to set up a SONET port on a trunk line unit:

ent-eqpt::n10-1-11:::oc12-4-ir;

ent-oc12::n10-1-11-1::::ext=n;

ent-sts12c::n10-1-11-1-1::::stsmap=atmnni;

The first line starting with “ent-eqpt” tells provisioning software that on node 10, shelf 1, slot 11, there is an intermediate reach card having four OC-12 ports. Note that this command is optional, e.g. if the card is self-provisioning and present in the chassis then this command is not required. However, use of this command allows one to do provisioning even if the card is not physically present in the chassis.

The second line starting with “ent-oc12” enables OC-12 traffic on node 10, shelf 1, slot 11, port 1. This command identifies one physical port (of the four ports on this subscriber line unit), where fiber comes in, carrying video data into the access multiplexer, from an upstream device. In this line, “ext=n” means that at the other end of the fiber is an upstream device that conforms to an architecture of which the access multiplexer is a part. The term “ext=y” would be used if the upstream device belongs to, for example, a different vendor.

The third line starting with “ent-sts” creates an STS connection on top of the just-described physical port. In this line, the term “n10-1-1-1-1” indicates that there is node 10, shelf 1, slot 11, port 1, STS-1.

Next, the following two lines are used to set up one ADSL port on a subscriber line unit:

ed-adsl::n10-1-1-9::::mdsr0=7232,musr0=800:oos;

ed-adsl::n10-1-1-9:::::is;

The first line puts the port out of service: namely node 10, shelf 1, slot 1, port 9. “mdsr0” means that the ADSL line is provisioned to use 7.232 Mbits bandwidth in the downstream direction and 800 kb bandwidth in the upstream direction.

Thereafter, in this example 10 transport VCs are set up using the following commands:

ent-crs-vc::n10-1-11-1-1-vp15-vc100,n10-1-11-PP2-vp15-vc100:::1way:trfprof=31;

ent-crs-vc::n10-1-11-1-1-vp15-vc101,n10-1-11-PP2-vp15-vc101:::1way:trfprof=31;

ent-crs-vc::n10-1-11-1-1-vp15-vc102,n10-1-11-PP2-vp15-vc102:::1way:trfprof=31;

ent-crs-vc::n10-1-11-1-1-vp15-vc103,n10-1-11-PP2-vp15-vc103:::1way:trfprof=31;

ent-crs-vc::n10-1-11-1-1-vp15-vc104,n10-1-11-PP2-vp15-vc104:::1way:trfprof=31;

ent-crs-vc::n10-1-11-1-1-vp15-vc105,n10-1-11-PP2-vp15-vc105:::1way:trfprof=31;

ent-crs-vc::n10-1-11-1-1-vp15-vc106,n10-1-11-PP2-vp15-vc106:::1way:trfprof=31;

ent-crs-vc::n10-1-11-1-1-vp15-vc107,n10-1-11-PP2-vp15-vc107:::1way:trfprof=31;

ent-crs-vc::n10-1-11-1-1-vp15-vc108,n10-1-11-PP2-vp15-vc108:::1way:trfprof=31;

ent-crs-vc::n10-1-11-1-1-vp15-vc109,n10-1-11-PP2-vp15-vc109:::1way:trfprof=31;

In the above lines, the term “ent-crs-vc” instructs access multiplexer 100 of this example to create a permanent virtual circuit (PVC), with two end points, each identifying the node, shelf, slot, physical port, STS (if port is SONET), and VPI and VCI. For example, the first line asks for creation of a PVC between node 10, shelf 1, slot 11, port 1, STS 1, VPI 15, VCI 100 and node 10, shelf 1, slot 11, pseudo port 2, and no STS, and end there as VPI 15 and VCI 100. In response to this first line, the access multiplexer creates a PVC from the physical SONET port to the pseudo port PP2 in the trunk line unit. In the first line, the term “1way” says the traffic is unidirectional, and the term “trfprof=31” is a short hand for specifying all the parameters in the traffic profile 31 (which was discussed above in the context of Video VC profile for video transport VC). Referring to FIG. 3A, a total of ten VCs 101A-101P have been now created.

Next, in this example, a single subscriber PVC is created as follows:

ent-crs-vc::n10-1-11-PP1-vp11-vc40,n10-1-1-9-ch0-vp1-vc34:::1way:trfprof=32;

In response to the above command, access multiplexer 100 creates a PVC from node 10, shelf 1, slot 11, pseudo port 1, VP 11, VC 40, to node 10, shelf 1, slot 1, port 9, channel 0, VPI 1, VCI 34. Note that VPI 11 and VCI 40 do not match the VPI/VCI of any of the ten trunk PVCs described in the previous paragraph. Therefore, at this stage, the single subscriber PVC does not carry any specific one of the ten video data flows being received in the network processor via the ten trunk PVCs.

In the above command, Channel 0 and Channel 1 are parameters that are to be specified for an ADSL port: channel 0 is normally used in this example. VC is going across the backplane, and therefore bandwidth needs to be allocated on the backplane for carrying this VC. The only difference between profiles 31 and 32 is the application type, which tells the switching software (in the IP unit) the use of the VC (e.g. for video). Note that each time an ATM VC is created, a message is sent to the software on the IP unit so that change control logic 111 can update its tables.

In this example, in addition to the above-described 10 trunk PVCs and one subscriber PVC, one may create two IP VCs:

ent-crs-vc::n10-1-18-PP1-vp10-vc44,n10-11-1-1-vp10-vc40::::trfprof=33;

ent-crs-vc::n10-1-18-PP1-vp10-vc45,n10-1-1 -9-ch0-vp8-vc35::::trfprof=33;

The first IP VC originates in node 10, shelf 1, slot 11, port 1 which is a real port coupled to an upstream router and ends in a pseudo-port PP1 in the IP unit (located in slot 18), and the second IP VC originates in the pseudo-port PP1 of the IP unit and ends at an ADSL port in the subscriber line unit, namely node 10, shelf 1, slot 1, port 9, channel 0, VPI 8, VCI 35. Reference to pseudo port PP1 indicates that bandwidth on the backplane needs to be allocated for these two PVCs. The first IP VC is used for IP traffic between an upstream router (coupled to head end equipment), and the IP unit. The second IP VC is used for IP traffic between a subscriber STB and the IP unit. The STB and the head end equipment communicate with each other over IP and the IP messages go via the IP unit. For this purpose the IP unit is acting as a layer-3 router. For example, IGMP channel change messages are sent by the STB over the just-described second IP VC, and the network processor recognizes these as IGMP messages and instead of forwarding them to the upstream router, they are sent to channel change logic 111 (which may be implemented, for example, as software executing in a programmed CPU). Channel change logic 111 contains one or more data tables to identify which subscriber the message came from. Then logic 111 sends a message to the trunk line unit, to form cross connection 121 (FIG. 3A).

Next, in this example, an association between layer-2 and layer-3 is created by the following commands:

/t/irc/vsc/add ch 225.1.1.10 15 100 ch100

/t/irc/vsc/add ch 225.1.1.1 15 101 ch101

/t/irc/vsc/add ch 225.1.1.2 15 102 ch102

/t/irc/vsc/add ch 225.1.1.3 15 103 ch103

/t/irc/vsc/add ch 225.1.1.4 15 104 ch104

/t/irc/vsc/add ch 225.1.1.5 15 105 ch105

/t/irc/vsc/add ch 225.1.1.6 15 106 ch106

/t/irc/vsc/add ch 225.1.1.7 15 107 ch107

/t/irc/vsc/add ch 225.1.1.8 15 108 ch108

/t/irc/vsc/add ch 225.1.1.9 15 109 ch109

In first line asks access multiplexer 100 to add a video channel 100, which is to be identified as being carried in packets having the multicast address 225.1.1.10 as the destination. This line identifies the content of data flowing over VPI 15 VCI 100, which is the first of the 10 transport VCs that were provisioned as described above. The term “ch100” at the end of this line is just a textual description of the video data flow, such as HBO.

The just-described mapping (between IP multicast address and VPI/VCI number of the data flow) allows access multiplexer 100 to implement a change in cell switching, in response to a channel change request. In response to the above commands, access multiplexer 100 associates the VPI/VCI numbers of the transport PVCs with the IP multicast address of the packets being carried in the cells. Therefore, it is not necessary for access multiplexer 100 to parse a packet's header and obtain the IP multicast address, when performing cell switching on the video data flows.

In this example, access multiplexer 100 also provides support for IP traffic from the STB to the Internet. All IP traffic from the STB goes to the IP unit, and all IP goes from the IP unit to a router and from the router to the destination (e.g. to head end equipment) and the Internet. For this support, one may create a layer-3 interface as follows:

/t/irc/vsc/add if 10.1.1.52 255.255.255.0

/t/irc/vsc/addho 0900a402fb9 10.1.1.51 10 1 11 1

The first line configures the IP address 10.1.1.52 as the IP address of the IP unit, and the mask defines a subnet which means that the interface is on 10.1.1.0. This is a static IP address. The second line shows how to identify the upstream neighbor: the term “add ho” means add the host, and the first address is the Etherent MAC address of the upstream router. The number 10.1.1.51 is the IP address of the router. Note that the ATM VC is not identified directly and instead the above command just says where it is located: node 10, shelf 1, slot 11 and port 1. The above statements form only port 1, and for this reason, at this stage, there is only one VC: which is the just-described IP VC to the router. As would be apparent to the skilled artisan, there could be multiple VCs on port 1, each of one of the above-described traffic profiles. For this reason, one may enter any number of additional IP static VCs, and the IP unit does layer-3 forwarding in the manner of normal IP.

Finally, in this example, one may create a layer-3 interface to the STB as follows:

/t/irc/vsc/add if 10.1.2.52 255.255.255.0

which adds the interface “if”10.1.2.52 as the IP address of the IP unit on this subnet (with the subscriber) which is different from the upstream subnet. And in the above line the term “255.255.255.0” is the mask. So the subnet is 10.1.2.0. This STB interface is at layer-3 and access multiplexer 100 performs provisioning of the IP address and the MAC address of each STB. Finally, the following line creates an actual subscriber record:

/t/irc/vsc/add sub 0010957010e2 10.1.2.51 10 11 9 1 0 settop51

In the above line, the term “0010957010e2” is the MAC address of the subscriber, which is used to forward the IP packets to the subscriber: because there's an Ethernet encapsulation layer. In the above line, the next term is the IP address of the subscriber which is in the same subnet as the IP unit, followed by the node, shelf, slot and port: 10 11 9. The next number is a “mode” number which indicates whether or not “fast” channel changing is to be done (based on modified IGMP as discussed above). The next number is the number of channels to the STB and 0 means only one channel is being used. The last string is an identifier of the STB, and could be, for example, “Mr. Jones on 27th street”.

In the-above-described example, channel change logic 111 may maintain a number of tables, such as a subscriber table, a channel table, and a VC table. The channel table identifies for each video data flow that is being received, the channel number (IP multicast group address such as 225.1.1.21), as well as the egress ATM VPI/VCI number (i.e. the VPI/VCI number in each cell of the data flow being received in the network processor), and a description of the channel (which may be just a text string, such as HBO).

The subscriber table is used to describe every subscriber, and a unique ID for each subscriber based on the subscriber's MAC address (which is a layer 2 address) can be used to look up this table. Each subscriber also has an IP address (which is a layer 3 address) that can also be used to perform a lookup in the subscriber table.

In one embodiment, the subscriber table also contains a link to a subscriber VC that is to carry the video data flow, and this VC is also identified in the above-described VC table. Initially, when a PVC is provisioned for carrying video data to the subscriber, a record that describes the PVC is set up and a pointer to the PVC record stored in the VC table. Later, when a subscriber is provisioned, this record is found (as a VC that goes out the same shelf, slot, port as the subscriber, and if the VC is not being used), and the record is then bound to the subscriber via the subscriber table (e.g. by storing a pointer to the VC record). On receipt of a channel change request, the subscriber table is looked up to identify the subscriber VC (e.g. a handle value) that is to be connected to a VC carrying the data flow being requested. Thereafter, the subscriber table is checked to confirm that the subscriber is not already receiving the requested data flow.

In an alternative embodiment, the actions described in the previous paragraph are not performed, and instead, in this embodiment the subscriber VCs reside in a subscriber VC pool that is attached to an entry in a port table. In such an embodiment, when it is needed to start a flow to a subscriber, an unused VC in the port pool is found and it is marked as being in use and it is used to carry the flow

In this example, an IP multicast address that identifies a channel is retrieved from the channel change request received from the subscriber, and this address is then used as an index into the channel table to obtain an identity of the trunk VC (e.g. a handle value). Next, the channel identifier is added to the subscribers' data in the subscriber table (e.g. to a list of channels that are being supplied on this port), for future use (to confirm receipt of same data flow as noted above). Depending on the embodiment, the just-described list of channels may be maintained in a separate table, called “port table” which may be indexed by port number.

Numerous modifications and adaptations of the embodiments, implementations and examples described herein will be apparent to the skilled artisan in view of this disclosure.

Although in several embodiments described above, a network processor 105 and channel change logic 111 are implemented in different integrated circuits that are located in different units (e.g. a trunk line unit and an IP unit respectively), other embodiments can implement the corresponding functionality differently. For example, as noted above channel change logic 111 can be implemented in the central switching unit. Alternatively, channel change logic can be implemented in a distributed manner, with a portion thereof being resident in each trunk line unit. In one such embodiment, channel change logic 111 is implemented in software on a CPU resident on each trunk line unit.

Moreover, instead of switching VCs, a network processor in an access multiplexer in accordance with this invention can perform VLAN switching. In such an embodiment, the network processor in the access multiplexer converts a flow of ATM cells into Ethernet packets, using RFC 1483 (that is incorporated by reference herein in its entirety) published by the Internet Engineering Task Force (IETF).

In such embodiments, apparatus 100 supports the provisioning of VLAN 802.1 Q tags for supporting video over Gigabit Ethernet and Fast Ethernet. The VLAN tags are used on the fiber access drop (e.g. over a FTTH link), to distinguish different traffic types (broadcast video, VOD streams, Internet, application server communication, and IGMP signaling). Furthermore, in some embodiments apparatus 100 assigns priority levels to different VLAN and limits the data rate of a given VLAN on an access drop. In addition, apparatus 100 supports the provisioning of Class of Service to allow a LEC to provision different service levels for Internet access.

Moreover, although video is transported in certain embodiments as MPEG/UDP/IP/Ethernet/AAL5/ATM in other embodiments video may be transported as MPEG/ATM (new). Note that in the just-described embodiments of both kinds, the multicast addresses that are used in IGMP messages to identify video channels are mapped by apparatus 100 into the egress VPI/VCI numbers of the transport VCs as discussed above.

Furthermore, although in certain implementations two pseudo ports are used, in another implementation only one pseudo port is used, and when VCs are specified, an additional parameter is specified which indicates whether or not bandwidth needs to be reserved on the backplane bus for the VC that is being set up. In such an implementation, use of one pseudo port is adequate because VC-VC associations can be made between any VCs that end at and originate at the pseudo port, in the same manner as a loopback between VCs as would be apparent to the skilled artisan in view of the disclosure

Also, although several embodiments support video over ADSL and/or VDSL, other embodiments support point-to-point Gigabit Ethernet, point-to-point Fast Ethernet, and Passive Optical Networks (PONs), as would be apparent to the skilled artisan in view of this disclosure.

One distinction over U.S. Pat. 6,097,720 in certain embodiments of the current invention is that PPP connections are eliminated by use of PVCs, so that a cross-connect in the physical layer is adequate

Moreover, although some embodiments use IGMP packets as noted above to change VC-VC associations, other embodiments use and are responsive to standard digital storage media-command and control (DSM-CC) channel change requests.

Furthermore, video headend equipment coupled to an upstream device may derive and groom video content for delivery to apparatus 100, and may contain a service management system to provide back office functions such as set-top service provisioning. Moreover, certain embodiments may connect xDSL, Gigabit Ethernet, or Fast Ethernet termination equipment in an in-home network, to apparatus 100 via xDSL or FTTH drop, and the in-home network may include settop hardware and middleware to deliver video services to the subscriber. The number of subscriber VCs that may be supported by various embodiments of apparatus 100 depends on the access technology,

In certain embodiments, for broadcast video, the video and audio components of each channel (such as HBO) are MPEG encoded and encapsulated into an MPEG single program transport stream. As noted above, depending on the CPE deployed, the MPEG transport streams are transported either over UDP/IP/Ethernet/AAL5/ATM or for some xDSL CPE, directly over AAL5/ATM. In both cases, each channel is carried on a unique ATM VPI/VCI.

In other embodiments that support voice on demand (VOD) traffic, the video streams are carried either as MPEG/UDP/IP/Ethernet/AAL5/ATM or for some xDSL CPE, directly over AAL5/ATM. In several embodiments, VOD streams are carried over PVCs of the type described herein (i.e. transport VCs and subscriber VCs). Other embodiments carry VOD streams over switched virtual connections (SVCs) of this type.

Apparatus 100 of several embodiments also supports Internet traffic which is carried as TCP/IP/Ethernet/AAL5/ATM or carried over PPPoA or PPPoE. Application signaling between the CPE and any headend management devices may be carried with or separate from Internet traffic as TCP/IP/Ethernet/AAL5/ATM or can be carried with the Internet traffic over PPPoA or PPPoE, depending on the embodiment.

Although logic 111 is described in certain embodiments as supporting only the change of video data flows, such logic 111 may be extended to support further Ethernet and IP layer functions not necessarily related to video. In addition, further cost reduction and network flexibility can be achieved by migrating these functions to the central switching unit (i.e. instead of having a separate IP unit).

Numerous such modifications and adaptations of the embodiments, implementations and examples described herein are encompassed by the attached claims.

1. A method of distributing a flow of data embedded in a plurality of cells to zero or more subscribers, the method comprising:
receiving a cell in conformance with the asynchronous transfer mode (ATM) protocol;
identifying zero or more virtual circuits of subscribers that are to receive the cell, using a VPIVCI number in the cell and a mapping between cell VPI/VCI numbers and the subscriber virtual circuits;
transmitting a copy of the cell on each subscriber virtual circuit that is identified, wherein identification of each subscriber virtual circuit provides at least an output VPI/VCI number and an output port;
repeating the acts of receiving, identifying and transmitting until a message is received from a subscriber requesting a new flow to be supplied thereto;
changing the mapping, to map a new VPI/VCI number of a cell of the new flow to the virtual circuit of the subscriber, without regard to an input VPI/VCI number of the subscriber's virtual circuit; and
returning to the act of repeating;
wherein the virtual circuit to each subscriber is kept intact during the method.

2. The method of claim 1 wherein:
the message from the subscriber requesting the new flow conforms to a layer-3 protocol.

3. The method of claim 1 wherein:
at least one of the flows is a video channel, and only one copy of the video channel is received.

4. The method of claim 1 wherein each virtual circuit is hereinafter “subscriber VC”, and wherein:
each cell is received on a virtual circuit (hereinafter “trunk VC”) having an egress end in a trunk line unit and an ingress end in an upstream device that is coupled to the trunk line unit by a SONET or SDH ring;
each subscriber VC has an ingress end in the trunk line unit and an egress end in the subscriber's customer premises equipment (CPE); and
the CPE is directly connected by a twisted pair of copper wires to a subscriber line unit that in turn is directly connected by a bus to the trunk line unit.

5. The method of claim 4 wherein:
each trunk VC also ends in the trunk line unit but does not require bandwidth on the bus; and
the message from the subscriber requesting the new flow is received through another virtual circuit that ends in a control unit, and the control unit is coupled to each of the trunk line unit and the subscriber line unit.

6. A method of operating a device (hereinafter “access multiplexer”) that is connected directly to customer premises equipment (hereinafter “CPE”) of a number of subscribers, the method comprising:
the access multiplexer receiving only one copy of each of a number of video channels available for distribution to the subscribers, each video channel being received as a flow of units of data;
the access multiplexer using an identifier (hereinafter “flow identifier”) in a header of each unit of data that is received, to find zero or more identifiers of virtual circuits (hereinafter “subscriber VCs”) to CPE of the subscribers, based on a mapping between flow identifiers and identifiers of subscriber VCs;
the access multiplexer transmitting a copy of the unit of data to each subscriber VC identified by the act of using the flow identifier with the mapping; and
the access multiplexer changing the mapping while maintaining each subscriber VC intact, by removing in the mapping an association of the flow identifier with the subscriber VC and adding in the mapping another association of a new flow identifier with the subscriber VC, after the access multiplexer receives a request (hereinafter “channel change request”) from the subscriber indicating a new video channel.

7. The method of claim 6 wherein:
each subscriber VC is a permanent virtual circuit (also called “subscriber PVC”);
when changing the mapping in response to a request from a subscriber, the access multiplexer does not remove an existing PVC for that subscriber; and
instead the access multiplexer continues to use that subscriber's PVC before and after the change in mapping, by transmitting units of data to that subscriber regardless of an input virtual port identifier (VPI) and input virtual channel identifier (VCI) of that subscriber's PVC.

8. The method of claim 6 wherein:
all units of data conform to a single protocol selected from the group consisting of (a) asynchronous transfer mode (ATM); (b) frame relay and (c) X.25; and
the access multiplexer uses the same VC to the subscriber before and after the change in mapping.

9. The method of claim 6 wherein:
each of the units of data is processed in the access multiplexer by functionality equivalent to layer-2 of the Open Systems Interconnection (OSI) reference model; and
the channel change request from the subscriber has a format equivalent to layer-3 of the OSI reference model.

10. The method of claim 9 wherein:
the CPE transmits the channel change request on a VC that carries packets in conformance with the Internet Protocol (hereinafter “IP”) to a unit (hereinafter “control unit”) that parses layer-3 headers.

11. The method of claim 10 wherein:
the control unit parses the header of the channel change request from the subscriber to obtain an IP multicast address which uniquely identifies the new video channel being requested by the subscriber; and
the control unit uses the IP multicast address with another mapping to determine the new number.

12. The method of claim 6 wherein:
the acts of receiving a unit of data, using the number in the header of the unit of data to identify the VCs, and transmitting a copy of the unit of data on each identified VC are performed at wire speed in hardware (hereinafter “trunk line unit”); and
the trunk line unit performs the act of changing the mapping only in response to a signal on a bus from hardware (hereinafter “control unit”) that parses the header of the request to obtain an Internet Protocol (hereinafter “IP”) multicast address which uniquely identifies the new video channel;
wherein each of the trunk line unit, the control unit and the bus are housed within a single cabinet that comprises the access multiplexer.

13. The method of claim 6 wherein:
the acts of receiving a unit of data, using the number in the header of the unit of data to identify the VCs, and transmitting a copy of the unit of data on each identified VC are performed at wire speed in hardware (hereinafter “trunk line unit”); and
the trunk line unit performs the act of changing the mapping only in response to a signal from hardware (hereinafter “control unit”) that parses the header of the request to obtain an Internet Protocol (hereinafter “IP”) multicast address which uniquely identifies the new video channel;
wherein the control unit is located in a central office, the trunk line unit is located in the access multiplexer housed in a remote terminal physically distant from the central office, the control unit is coupled to the trunk line unit by a high speed link, and said signal from the control unit and only one copy of the video channels are transmitted on the high speed link, from the central office to the remote terminal.

14. A method of supplying video, the method comprising:
setting up a virtual circuit (hereinafter “subscriber VC”) having one end (hereinafter “ingress end”) in equipment (hereinafter “access multiplexer”) of a service provider, and another end (hereinafter “egress end”) in equipment (hereinafter “CPE”) of a subscriber, wherein the subscriber VC is carried only by a local loop between the access multiplexer and the CPE;
setting up another virtual circuit (hereinafter “trunk VC”) having one end (hereinafter “egress end”) in the access multiplexer and another end (hereinafter “ingress end”) in a device (hereinafter “upstream node”);
wherein the upstream node and the access multiplexer communicate with one another via a physical layer protocol that conforms to a plesiochronous digital hierarchy;
the access multiplexer forming a mapping between the trunk VC and the subscriber VC, after the CPE transmits to the access multiplexer a request to receive a flow of data in the trunk VC;
the access multiplexer receiving only one copy of the flow of data via a trunk VC from the upstream node; and
the access multiplexer transmitting a copy of the flow of data to the subscriber VC based on the mapping and regardless of any identifier of the ingress end of the subscriber VC.

15. The method of claim 14 wherein the act of transmitting performed by the access multiplexer comprises:
modulating a carrier wave with the flow of data to obtain a modulated signal; and
directly sending the modulated signal over the local loop to the CPE of said subscriber.

16. The method of claim 14 wherein:
the access multiplexer receives the flow of data in a first line unit (hereinafter “trunk line unit”) contained therein; and
the access multiplexer transmits the flow via a second line unit (hereinafter “subscriber line unit”) also contained therein, the subscriber line unit being directly connected to the local loop of the subscriber; and
the trunk line unit and the subscriber line unit are both housed in a single cabinet and are both directly coupled to one another by a bus located within the cabinet.

17. The method of claim 14 wherein the flow of data is hereinafter “first video channel”, and the access multiplexer receives only one copy of a second flow of data via a second trunk VC, the method further comprising:
after the CPE transmits a request for the second flow of data, the access multiplexer changing the mapping while keeping the subscriber VC intact and without performing any VC provisioning; wherein a new mapping associates the subscriber VC with the second trunk VC; and
the access multiplexer using the new mapping to transmit the second flow of data to the subscriber VC.

18. An apparatus comprising:
a first line unit (hereinafter “optical line unit”) that receives a single copy of number of flows of data for distribution to subscribers;
a number of second line units (hereinafter “subscriber line units”) that are directly coupled to local loops of subscribers, each subscriber line unit being coupled to the optical line unit by a bus;
a network processor that transfers zero or more flows of data from the optical line unit into each subscriber line unit based on a mapping contained therein, between identifiers of flows and identifiers of subscribers; and
a control unit coupled to the network processor to update the mapping, in response to a message from a subscriber.

19. The apparatus of claim 18 wherein:
each flow of data is received in the optical line unit via a virtual circuit (hereinafter “transport VC”);
the zero or more flows of data are transmitted by the optical line unit to zero or more subscriber line units via zero or more virtual circuits (hereinafter “subscriber VC”);
the network processor is located within the optical line unit, between the transport VCs and the subscriber VCs, the network processor being configured to transfer a copy of a data flow from a transport VC to each subscriber VC identified by the mapping;
the control unit is configured to update the mapping in the network processor by issuing instructions that keep all VCs intact;
wherein the mapping does not require any identifier of an ingress end of the subscriber VC.

20. The apparatus of claim 18 wherein:
the bus, the optical line unit and all subscriber line units are housed in a single cabinet; and
the cabinet is located in a remote terminal or a central office.

21. A method of distributing to each of a number of subscribers one of a number of flows of data, the method comprising:
using an access multiplexer that is coupled to each subscriber by a local loop to end each virtual circuit (hereinafter “trunk VC”) carrying a flow of data from an upstream device before the flow of data reaches a subscriber;
using the access multiplexer to originate a virtual circuit (hereinafter “subscriber VC”) to each subscriber, to supply one of the flows of data being received in the trunk VCs;
forming a mapping in the access multiplexer, between each subscriber VC and a trunk VC that carries a data flow requested by the subscriber, regardless of any identifier of the ingress end of the subscriber VC; and
for each data flow received from a trunk VC, the access multiplexer transferring a copy of the data flow to zero or more subscriber VCs identified by the mapping.

22. The method of claim 21 further comprising:
in response to a request from a subscriber to provide a second flow of data different from a first flow of data being currently received at an egress end of a subscriber VC to the subscriber, the access multiplexer replacing in the mapping a first identifier of a first trunk VC currently associated with the subscriber VC with a second identifier of a second trunk VC carrying the second flow of data while keeping the subscriber VC intact and without performing VC provisioning.

23. A method of distributing to each of a number of subscribers one of a numbers of flows of data, the method comprising:
using an access multiplexer that is coupled to each subscriber by a local loop, to transfer a copy of a data flow to zero or more subscriber VCs identified by an internal mapping; and
in response to a request, erasing in the mapping, an identifier of the subscriber VC associated with a first trunk VC carrying the data flow being currently received and adding to the mapping the identifier of the subscriber VC in association with a second identifier of a second trunk VC carrying another data flow that has been identified in the request, without tearing down or setting up the subscriber VC.

24. The method of claim 23 wherein:
each of the first trunk VC and the second trunk VC ends in a first logical port;
the subscriber VC originates in a second logical port;
the access multiplexer initially forms a temporary VC-VC association between the first trunk VC and the subscriber VC; and
in response to the request, the access multiplexer replacing the temporary VC-VC association with another temporary VC-VC association between the second trunk VC and the subscriber VC, without performing any ATM signaling.

25. The method of claim 23 wherein:
the request from the subscriber has format of a message defined in Internet Group Management Protocol.

26. The method of claim 25 wherein:
the access multiplexer maintains a count of the number of subscribers on each port that desire a data flow being provided to the port; and
in response to the request, the access multiplexer uses the count to determine if any other subscriber desires the data flow identified in the request, and if the count is zero the access multiplexer immediately stops the data flow without sending a Group Specific Query message on the port.

27. The method of claim 23 wherein:
each subscriber VC originates in a first pseudo port in a network processor;
each trunk VC ends in a second pseudo port in said network processor; and
the network processor performs the transfer of data flow between the first pseudo port and the second pseudo port, using the mapping.
